(19) United States
(12) Patent Application Publication
(10) Pub. No.: US 2026/0245481 A1
(43) Pub. Date: Aug. 20, 2026

(54) NEUROMODULATION SURGICAL TRAINING SYSTEM

(71) Applicant: Amber Therapeutics Holdings Limited, Didcot (GB)

(72) Inventors: Stefan de Wachter, Antwerp (BE); Nazir-Ahmed Karbanee, York (GB); Jacob William Kerr, London (GB); Bradley John Stanley-Clamp, Brighton (GB)

(21) Appl. No.: 19/543,250

(22) Filed: Feb. 18, 2026

Related U.S. Application Data
(60) Provisional application No. 63/760,273, filed on Feb. 19, 2025.

(51) Int. Cl. G09B 23/34

(52) U.S. Cl. CPC G09B 23/34

(57) ABSTRACT

A neuromodulation surgical training system disclosed herein provides a physical training apparatus in the form of an anatomical model and used for training the implantation of leads for electrical stimulation. The neuromodulation surgical training system may be used in conjunction with at least one of a virtual environment or an augmented environment. In some cases, the neuromodulation surgical training system may be fully implemented in a virtual or augmented environment.

### INCORPORATION BY REFERENCE TO ANY PRIORITY APPLICATIONS

This application claims the benefit of U.S. Provisional Application No. 63/760273, filed Feb. 19, 2025, the entire disclosure of which is hereby incorporated by reference herein in its entirety.

### BACKGROUND

### Field

The present disclosure generally relates to systems and methods for neuromodulation surgical training. For example, the systems and methods disclosed herein provide training for placement of a device (including but not limited to a neurostimulation lead) using a physical training apparatus and/or a virtual or augmented training environment, which, alone or combined, improves the flexibility of surgical training and provides key feedback for surgeons at each step of the training procedure.

### Description of the Related Art

Electrical stimulation can be used to treat incontinence, pelvic pain, sexual dysfunction, or other pelvic conditions. In particular, electrodes may be implanted in a pelvic region of the subject to provide electrical stimulation as clinical treatment and/or condition management. Providing implanted electrodes for treatment and/or condition management are limited by the ability of a surgeon to place the electrode lead at a specific target location in the pelvic region to improve effectiveness of the stimulation.

Many surgical techniques have been effectively trained on cadavers. However, for surgical techniques involving neuromodulation or neurostimulation, the differences in tissue composition and observed EMG responses in a frozen specimen versus a live patient may cause training on cadavers to be much less effective.

### SUMMARY

The effectiveness of neuromodulation or neurostimulation treatment may greatly depend on the proper placement of the leads at the target nerve(s). Thus, effective training systems and methods that may accurately simulate responses (such as EMG) and provide various feedback outputs for surgeons are needed. Several embodiments described herein advantageously provide a physical training apparatus in the form of an anatomical model to provide a robust and realistic simulation of the placement of an implantable electrode lead and/or other device. Several embodiments described herein advantageously use a computer-generated virtual or augmented environment to provide flexibility in surgical training and eliminate the need for labs, specimens, and/or physical equipment.

Properly placing an implanted electrode lead at one or more target nerves and/or tissue adjacent the one or more nerves may improve the robustness of delivering spatially controlled stimulation to the one or more nerves to treat and/or manage a condition, for example a pelvic condition. In some cases, the pelvic condition comprises urinary incontinence (e.g., stress, urge, or mixed incontinence), fecal incontinence, pain, sexual dysfunction, or any combination thereof. The electrode lead may be implanted at one or more target nerves in the pelvis. For example, the target nerve(s) may comprise one or more of the pudendal nerve, tibial nerve, peroneal nerve, sacral nerve, cauda equina, pelvic parasympathetic nerves, lumbar sympathetic nerves, and/or nerve branches leading to and from such nerves.

Although several embodiments are described herein with respect to the pelvic region to treat pelvic conditions, e.g., incontinence, they may also be used for training in other regions of the body or training to treat other conditions as described elsewhere herein. In some embodiments, the devices and methods may be used to train users for surgical techniques performed in or near the spine to treat, for example, pain. In some embodiments, the devices and methods may be used to train users for surgical techniques performed in or near the cranial region to treat, for example, headaches, migraines, etc. The training may be directed to implanting an electrode lead in tissue including, but not limited to, spinal, pelvic shoulder, knee, hip or cranial tissue.

The effective training of surgeons on the nuances of surgical technique is a critical step when onboarding new surgeons. When placing an electrode lead for stimulation), a surgeon may be required to be familiar with the instrumentation, implants, and the key landmarks of the procedure. An electrode lead that is improperly placed may not elicit a response in one or more target areas and therefore lose its utility to provide its beneficial effect of providing treatment and/or managing the condition. Thus, several embodiments described herein provide robust and realistic simulated training for inserting an instrument to a target location using a physical training apparatus to provide users with key feedback, for example x-ray images, ultrasound images, bioelectrical responses (e.g., EMG), and/or pressure responses at each step of the procedure. The proper delivery of devices other than electrode leads are achieved in various embodiments. For example, the training systems described herein can also facilitate surgical techniques using non-implantable or acute devices such as catheters, e.g., drug delivery catheters or drainage catheters, or other medical devices having an elongate structure.

The devices, systems, methods, and/or kits described elsewhere herein describe a physical training apparatus comprising a conductive material and one or more sensors (e.g., an array of one or more sensing electrodes). An elongate medical instrument outputting electrical stimulation, e.g., a stimulating needle, may be inserted into the conductive material, and readings from the one or more sensors (e.g., array of electrodes) may be used to determine a position of the instrument within the training apparatus. In other embodiments, the one or more sensors may be located in the medical instrument instead of the physical training apparatus. The devices, systems, methods, and/or kits described elsewhere herein may provide a simulated or actual medical image (e.g., x-ray image) of the instrument and the training apparatus. The devices, systems, methods, and/or kits described elsewhere herein may provide a monitoring unit to simulate the bioelectrical responses of a patient based on the position of the instrument within the training apparatus. By using a physical training apparatus, one may avoid the logistical challenges in securing specimens and labs, surgeon travel and availability, associated costs, limited usage per specimen, and unnecessary x-ray exposure.

The devices, systems, methods, and/or kits described elsewhere herein may use a computer-generated virtual or augmented environment alone, or in combination with, the physical training apparatus described elsewhere herein, to provide flexible and realistic surgical training. The position of the pelvis and the instrument may be tracked and replicated in the virtual environment, without the use of a physical model. A virtual set of implants, instruments, packaging, labelling, and the anatomical volume may be imported into the virtual or augmented environment. A user may manipulate and assemble the instruments and implants as they would in reality, and are able to see key feedback such as simulated x-ray in multiple views and the expected bioelectrical responses and/or simulated haptic feedback. In some implementations, robotic arm(s) and/or robotic control may be used for training of the surgical procedure. In some cases, stereotactic guidance may be used for manually and/or robotically-assisted placement and/or manipulation of the instruments and/or implants during the procedure.

There are numerous advantages to be gained through the use of virtual or augmented environments for the aid and training of health-care professionals. A sensory immersive environment provides the user with additional information that allows the user to increase the effectiveness of therapeutic procedures. The sensory immersive environment may provide an opportunity to learn through personal, participatory experience, a modality that is recognized as an effective way for humans to gain and retain a deep understanding of subject matter as well as physical and mental processes. Moreover, immersion in a virtual or augmented environment can allow the health-care professional and/or trainee to develop an understanding of the subject matter through physical interaction including manipulation of objects, a central aspect to the process by which humans learn. Virtual or augmented environments provide advanced techniques for visualization of subject matter as well, which can enable the health-care professional and/or trainee to sometimes perceive that which is imperceptible. In addition, virtual or augmented environments can simulate challenging scenarios (e.g., anatomy, fault scenarios, etc.) to train surgeon response. For example, abstract notions such as biological processes—which in the real world cannot be observed—can be simulated, visualized, and experienced in a sensory immersive environment. Thus, a virtual or augmented environment permits learning in contexts that are difficult or impossible to experience in real life. Illustratively, a virtual or augmented environment can deliver a wide range of observational perspectives (from extreme close-up to great distance) which sometimes cannot be easily achieved in the real world. For example, a virtual or augmented environment can display a medical instrument penetrating a portion of an anatomy with a three-dimensional view of the internal anatomy or from a perspective of being inside the anatomy.

In several embodiments, the neuromodulation training systems described herein, and uses thereof, have at least one or more of the following features or advantages:
provide a physical training apparatus for robust and repeatable training of surgical techniques involving insertion of a medical instrument;
provide a virtual or augmented environment for flexible and repeatable training of surgical techniques involving insertion of a medical instrument;
providing real-time training feedback in the form of simulated instrument position shown on images (e.g., x-ray images) or simulated bioelectrical response(s) for effective surgical training;
providing training for adjusting pelvic orientation with respect to x-ray
provide training for post-implantation techniques such as stimulation setup and programming.

In some embodiments, a surgical training system configured for training of a neuromodulation surgical technique (such as placement of an electrode lead in a pelvis) is provided. The system may include a training apparatus comprising an anatomical model of a pelvis (or other target region). The system may further include an instrument configured to be inserted into the training apparatus. The instrument may comprise a stimulating needle. The system may further include a processing unit. The processing unit may be configured to determine a position of the instrument relative to the pelvis modeled by the training apparatus. The system (e.g., processing unit) may be further configured to cause a display device to display an image of the pelvis, for example a simulated x-ray image or an actual x-ray image of a subject or the training apparatus. The x-ray image may include a depiction or representation of the instrument at the determined position relative to the pelvis. The system (e.g., processing unit) may be further configured to cause a monitoring unit to output feedback based on the determined position of the instrument. The feedback may comprise one or more bioelectrical responses representative of a live patient and indicative of proximity of the instrument to a pudendal nerve of the training apparatus.

In some embodiments, the system disclosed herein may include one or more orientation sensors on the training apparatus configured to measure an orientation of the training apparatus. The one or more orientation sensors may comprise a gyroscope. The displayed image of the pelvis may have an orientation corresponding to a measured orientation of the training apparatus. The displayed image of the pelvis may comprise one or more different perspective views of the pelvis. In some embodiments, the system (e.g., processing unit) may be further configured to generate at least one of a virtual environment or an augmented environment. The display device may be configured to display the image in the at least one of the virtual environment or the augmented environment. The display device may be configured to display the one or more bioelectrical responses in the at least one of the virtual environment or the augmented environment.

In some embodiments, the training apparatus may provide haptic feedback to a user as the instrument, e.g., a stimulating needle, is inserted into the training apparatus.

In some embodiments, a surgical training system configured for training of a neuromodulation surgical technique (such as placement of an electrode lead in a pelvis or other region) is provided. The surgical training system may be specific to a pudendal nerve only, e.g., for training implantation of an electrode lead at a position for stimulating a pudendal nerve without stimulating a sacral nerve. Alternatively, the pudendal, sacral and/or other nerves may be targeted. The surgical training system may comprise a training apparatus comprising an anatomical model of a pelvis (or other target region). The training apparatus may further comprise one or more sensors. The pudendal nerve surgical training system may further comprise a needle configured to be inserted into the training apparatus. The surgical training system may further comprise a processing unit configured to determine a position of the needle relative to the pelvis modeled by the training apparatus based on data received from the one or more sensors. The processing unit may be further configured to cause a display device to display one or more x-ray images of the pelvis including a depiction of the needle at the determined position relative to the pelvis. The processing unit may be further configured to cause a monitoring unit to output feedback based on the determined position of the needle, wherein the feedback comprises one or more bioelectrical responses representative of a live patient and indicative of proximity of the needle to a pudendal nerve of the training apparatus. In some cases, the needle may be a stimulating needle configured to output electrical stimulation and configured to be inserted into a conductive material of the training apparatus. The one or more sensors may comprise an array of electrodes configured to sense electrical signals from the electrical stimulation. The array of one or more electrodes may be placed along a predetermined pathway for the stimulating needle to be inserted. The predetermined pathway may follow an ischiorectal approach to the pudendal nerve of the training apparatus. The training apparatus may further comprise one or more orientation sensors, e.g., a gyroscope, configured to measure an orientation of the training apparatus. The displayed x-ray image of the pelvis may have an orientation corresponding to a measured orientation of the training apparatus. The training apparatus may provide haptic feedback to the user as the needle is inserted into the training apparatus. The displayed x-ray image of the pelvis may comprise one or more different perspective views of the pelvis. Instead of the pelvis, other regions (e.g., spine, cranium, etc. may be modeled to permit training for other nerves).

In some embodiments, a pudendal nerve surgical training system configured for training of a neuromodulation surgical technique (such as placement of an electrode lead in a pelvis) is provided. The pudendal nerve surgical training system may be specific to a pudendal nerve only, e.g., for training implantation of an electrode lead at a position for stimulating a pudendal nerve without stimulating a sacral nerve. The pudendal nerve surgical training system may comprise a training apparatus comprising an anatomical model of a pelvis. The training apparatus may further comprise a conductive material and an array of one or more electrodes on or within the conductive material and configured to sense electrical signals from electrical stimulation. The pudendal nerve surgical training system may further comprise a stimulating needle configured to be inserted into the conductive material of the training apparatus. The stimulating needle may be configured to output the electrical stimulation. The pudendal nerve surgical training system may further comprise a processing unit configured to receive sensor data from the array of one or more electrodes. The processing unit may be further configured to determine, based on the sensor data, a position of the stimulating needle relative to the pelvis modeled by the training apparatus. The processing unit may be further configured to cause an output of feedback based on the determined position of the stimulating needle. The feedback may comprise one or more simulated bioelectrical responses representative of a live patient and indicative of proximity of the stimulating needle to a pudendal nerve of the training apparatus. The conductive material may comprise conductive foam. The processing unit may be configured to determine the position by calculating a distance of a portion of the stimulating needle to each of the one or more electrodes based on the sensor data. The array of one or more electrodes may be placed along a predetermined pathway for the stimulating needle to be inserted. The predetermined pathway may follow an ischiorectal approach to the pudendal nerve of the training apparatus. The processing unit may be further configured to cause a display device to display an image of the pelvis including a depiction of the stimulating needle at the determined position relative to the pelvis. The training apparatus may further comprise one or more orientation sensors, e.g., a gyroscope, configured to measure an orientation of the training apparatus. The displayed image of the pelvis may have an orientation corresponding to a measured orientation of the training apparatus. The training apparatus may provide haptic feedback to the user as the needle is inserted into the training apparatus. The feedback comprising one or more simulated bioelectrical responses may be output by a monitoring unit.

In some embodiments, a non-transitory, computer-readable medium comprising computer executable instructions for training a neuromodulation surgical technique (such as placement of an electrode lead) associated with a l nerve is provided. The computer executable instructions may be specific to a pudendal nerve only, e.g., for training implantation of an electrode lead at a position for stimulating a pudendal nerve without stimulating a sacral nerve. Alternatively, other nerves may be targeted. The computer-executable instructions, when executed by a computer system, may cause the computer system to receive data from one or more sensors of a training apparatus comprising an anatomical model of a pelvis. The computer-executable instructions, when executed by a computer system, may further cause the computer system to determine a position of a stimulating needle inserted into the training apparatus, based on the data received from the one or more sensors. The computer-executable instructions, when executed by a computer system, may further cause the computer system to generate an image of the pelvis including a depiction of the stimulating needle at the determined position relative to the pelvis. The computer-executable instructions, when executed by a computer system, may further cause the computer system to cause an output of feedback based on the determined position of the instrument, wherein the feedback comprises one or more simulated bioelectrical responses representative of a live patient and indicative of a proximity of the instrument to a pudendal nerve of the training apparatus.

In some embodiments, a method of training a neurostimulation surgical technique (such as placement of an electrode lead in a pelvis or other region) is provided. The method may include providing a training apparatus comprising an anatomical model of the pelvis. The method may further include providing an instrument configured to be inserted into the training apparatus. The instrument may comprise a needle, a stimulating needle, guidewire, introducer, or other elongate device for accessing a nerve of the pelvis. The method may further include inserting the instrument into the training apparatus. The training apparatus may comprise a processing unit. The method may further include determining, by the processing unit, the position of the instrument relative to the pelvis modeled by the training apparatus. The method may further include causing the display device to display an image of the pelvis. The image may be an x-ray image, MRI image, CT scan, or other image. The image may include a depiction of or representation of the instrument at the determined position relative to the pelvis. The method may further include causing the monitoring unit to output feedback based on the determined position of the instrument. The feedback may comprise one or more bioelectrical responses representative of or mimicking a live patient and indicative of proximity of the instrument to a pudendal nerve of the training apparatus.

In some embodiments, a kit for training a neurostimulation surgical technique (such as placement of an electrode lead in a pelvis or other region) is provided. The kit may include a training apparatus comprising an anatomical model of a pelvis. The kit may further include one or more instruments configured to be inserted into the training apparatus. The one or more instruments may comprise a needle, a stimulating needle, a guidewire, an introducer, or other elongate instrument to access the nerves in the pelvis. The kit may further include a processing unit. The processing unit may be configured to determine a position of the one or more instruments relative to the pelvis modeled by the training apparatus. The kit may further include a display device. The display device may be configured to display an image of the pelvis. The image may be an x-ray image, MRI image, CT scan, or other image. The displayed image may include a depiction of or representation of the one or more instruments at the determined position relative to the pelvis. The kit may further include a monitoring unit configured to output feedback based on the determined position of the one or more instruments. The feedback may comprise one or more bioelectrical responses representative of or mimicking a live patient and indicative of proximity of the one or more instruments to a pudendal nerve of the training apparatus.

In some embodiments, a surgical training system configured for training of a neurostimulation surgical technique (such as placement of an electrode lead in a pelvis) is provided. The system may include a training apparatus comprising an anatomical model of a pelvis. The training apparatus may comprise a conductive material. The conductive material may comprise a conductive foam. In some embodiments, the conductive material may comprise synthetic tissue. The system may further include a stimulating instrument (e.g., needle) configured to be inserted into the conductive material and output electrical stimulation. The system may further include an array of one or more electrodes on or within the conductive material. The array of one or more electrodes may be configured to sense electrical signals from the electrical stimulation of the stimulating instrument. The system may further include a processing unit. The processing unit may be configured to receive sensor data from the array of one or more electrodes. The system (e.g., processing unit) may be further configured to determine a position of the stimulating instrument relative to the pelvis modeled by the training apparatus, based on the sensor data. The system (e.g., processing unit) may be further configured to cause a monitoring unit to output feedback based on the determined position of the stimulating needle. The feedback may comprise one or more bioelectrical responses representative of or mimicking a live patient and indicative of proximity of the stimulating instrument to a target nerve of the training apparatus. The target nerve may comprise one or more of the pudendal nerve, tibial nerve, peroneal nerve, sacral nerve, cauda equina, pelvic parasympathetic nerves, lumbar sympathetic nerves, and/or nerve branches leading to and from such nerves. In one embodiment, the target nerve comprises one or more nerves that result in incontinence, sexual dysfunction and/or pain. In one embodiment, the target nerve comprises one or more nerves that result in overactive bladder.

In some embodiments, the system (e.g., processing unit) disclosed herein may be further configured to cause a display device to display an image of the pelvis including a depiction of the stimulating needle at the determined position relative to the pelvis.

In some embodiments, the array of one or more electrodes may be placed along a predetermined pathway for the stimulating needle. The predetermined pathway may follow an ischiorectal approach into the pelvis. The systems (e.g., processing unit) disclosed herein may be further configured to determine the position by calculating a distance of a portion of the stimulating needle to each of the one or more electrodes based on the sensor data.

In some embodiments, the system may further include one or more orientation sensors on the training apparatus configured to measure an orientation of the training apparatus. The one or more orientation sensors may comprise a gyroscope. The displayed image of the pelvis may have an orientation corresponding to a measured orientation of the training apparatus. The displayed image of the pelvis may comprise one or more different perspective views of the pelvis. In some embodiments, the system (e.g., processing unit) may be further configured to generate at least one of a virtual environment or an augmented environment. The display device may be configured to display the image in the at least one of the virtual environment or the augmented environment. The display device may be configured to display the one or more bioelectrical responses in the at least one of the virtual environment or the augmented environment. In some embodiments, the training apparatus may provide haptic feedback to a user as the stimulating needle, or some other instrument, is inserted into the training apparatus.

In some embodiments, a surgical training system configured for training of a neurostimulation surgical technique (such as placement of an electrode lead in a pelvis or other region) is provided. The system may include a training apparatus comprising an anatomical model of a pelvis. The training apparatus may comprise a conductive material and one or more orientation sensors. The conductive material may comprise a conductive foam. In some embodiments, the conductive material may comprise synthetic tissue. The one or more orientation sensors may be configured to measure an orientation of the training apparatus. The system may further include an stimulating instrument (e.g., needle) configured to be inserted into the conductive material and output electrical stimulation. The system may further include an array of one or more electrodes on or within the conductive material. The array of one or more electrodes may be configured to sense electrical signals from the electrical stimulation of the stimulating instrument. The system may further include a processing unit. The processing unit may be configured to receive sensor data from the array of one or more electrodes. The system (e.g., processing unit) may be further configured to determine a position of the stimulating instrument relative to the pelvis modeled by the training apparatus, based on the sensor data. The system (e.g., processing unit) may be further configured to determine an orientation of the training apparatus using the one or more orientation sensors. The system (e.g., processing unit) may be further configured to cause a display device to display an image of the pelvis including a depiction of the stimulating instrument at the determined position relative to the pelvis, wherein the image has an orientation corresponding to the determined orientation of the training apparatus. The image may be an x-ray image, MRI image, CT scan, or other image. In some embodiments, the training apparatus may provide haptic feedback to a user as the stimulating needle, or some other instrument, is inserted into the training apparatus.

In some embodiments, the system (e.g., processing unit) disclosed herein may be further configured to cause a monitoring unit to output feedback based on the determined position of the stimulating instrument (e.g., needle), wherein the feedback comprises one or more bioelectrical responses representative of or mimicking a live patient and indicative of proximity of the stimulating instrument to a target nerve of the training apparatus. The target nerve may comprise one or more of the pudendal nerve, tibial nerve, peroneal nerve, sacral nerve, cauda equina, pelvic parasympathetic nerves, lumbar sympathetic nerves, and/or nerve branches leading to and from such nerves.

In some embodiments, the array of one or more electrodes may be placed along a predetermined pathway for the stimulating instrument. The predetermined pathway may follow an ischiorectal approach into the pelvis. The systems (e.g., processing unit) disclosed herein may be further configured to determine the position by calculating a distance of a portion of the stimulating needle to each of the one or more electrodes based on the sensor data.

In some embodiments, the one or more orientation sensors may comprise a gyroscope. The displayed image of the pelvis may comprise one or more different perspective views of the pelvis.

In some embodiments, the systems (e.g., processing unit) disclosed herein may be further configured to generate at least one of a virtual environment or an augmented environment. The display device may be configured to display the image in the at least one of the virtual environment or the augmented environment. The display device may be configured to display the one or more bioelectrical responses in the at least one of the virtual environment or the augmented environment.

In some embodiments, a surgical training system configured for training of a neurostimulation surgical technique (such as placement of an electrode lead in a pelvis) is provided. The system may include a computing system comprising a processor and a memory device. The computing system may be configured to generate at least one of a virtual environment or an augmented environment including a training model of a pelvis and an instrument. The system may further include a display device coupled to the computing system. The processor may be configured to cause the display device to display the at least one of the virtual environment or the augmented environment. The at least one of the virtual environment or the augmented environment may be a stereoscopic representation. The processor may be further configured to determine a position of the instrument relative to the training model. The processor may be further configured to cause the display device to display a virtual image of the pelvis. The virtual image may include a depiction of or representation of the instrument at the determined position relative to the pelvis. The processor may be further configured to cause the display device to display one or more simulated bioelectrical responses. The one or more simulated bioelectrical responses may be based on the determined position of the instrument and indicative of proximity of the instrument to a pudendal nerve of the training model. The processor may further be configured to cause the display device to display a checklist showing one or more steps for training.

In some embodiments, the computing system may generate the augmented environment. The training model may comprise a physical training apparatus and the instrument may comprise a stimulating needle.

In some embodiments, a surgical training system configured for training of a neurostimulation surgical technique (such as placement of an electrode lead in a pelvis) is provided. The system may include a computing system comprising a processor and a memory device. The computing system may be configured to generate at least one of a virtual environment or an augmented environment including a virtual training model of a pelvis and a virtual instrument. The system may further include a display device coupled to the computing system. The processor may be configured to cause the display device to display the at least one of the virtual environment or the augmented environment. The at least one of the virtual environment or the augmented environment may be a stereoscopic representation. The system may further include a user input device. The user input device may comprise one or more handheld controllers. The user input device may be configured to allow a user to interact with the virtual training model. The virtual instrument may be configured to mimic movement of the user input device. The processor may be further configured to determine a position of the instrument relative to the virtual training model. The processor may be further configured to cause the display device to display one or more simulated bioelectrical responses. The one or more simulated bioelectrical responses may be based on the determined position of the instrument and indicative of proximity of the instrument to a target nerve of the virtual training model. For example, the target nerve(s) may comprise one or more of the pudendal nerve, tibial nerve, peroneal nerve, sacral nerve, cauda equina, pelvic parasympathetic nerves, lumbar sympathetic nerves, and/or nerve branches leading to and from such nerves. The target nerve may comprise a pudendal nerve. The processor may further be configured to cause the display device to display a checklist showing one or more steps for training.

In some embodiments, the system (e.g., processor) may be further configured to output haptic feedback to the user input device based on the determined position of the virtual instrument. The haptic feedback may comprise vibration.

In some embodiments, the system (e.g., processor) may be further configured to cause the display device to display a virtual image of the pelvis. The virtual image may include a depiction of the virtual instrument at the determined position relative to the pelvis.

In some embodiments, the virtual instrument may be prevented from moving outside of a plane of the virtual training model after insertion into the virtual training model. The system (e.g., processor) may be further configured to cause the display device to display an alert when the user input device is moved a threshold distance from the plane of the virtual training model.

In some embodiments, the virtual training model may show one or more internal anatomical structures in a training mode. The virtual training model may not show any internal anatomical structures when not in the training mode. The one or more internal anatomical structures may comprise a pudendal nerve.

In some embodiments, the user input device may be configured to receive a user input for simulating a pulse from the virtual instrument. The system (e.g., processor) may be further configured to generate the one or more simulated bioelectrical responses based on the position of the virtual instrument when the user input was received.

In some embodiments, a surgical training system configured for training of a neurostimulation surgical technique (such as placement of an electrode lead in a pelvis) is provided. The system may include a computing system comprising a processor and a memory device. The computing system may be configured to generate at least one of a virtual environment or an augmented environment including a virtual training model of a pelvis and a virtual instrument. The system may further include a display device coupled to the computing system. The processor may be configured to cause the display device to display the at least one of the virtual environment or the augmented environment. The at least one of the virtual environment or the augmented environment may be a stereoscopic representation. The system may further include a user input device. The user input device may comprise one or more handheld controllers. The user input device may be configured to allow a user to interact with the virtual training model. The virtual instrument may be configured to mimic movement of the user input device. The processor may be further configured to determine a position of the virtual instrument relative to the virtual training model. The processor may be further configured to cause the display device to display a virtual image of the pelvis including a depiction of the virtual instrument at the determined position relative to the pelvis.

In some embodiments, the system (e.g., processor) may be further configured to cause the display device to display one or more simulated bioelectrical responses. The one or more simulated bioelectrical responses may be based on the determined position of the virtual instrument and indicative of proximity of the virtual instrument to a target nerve of the virtual training model. The target nerve may comprise a pudendal nerve.

In some embodiments, the system (e.g., processor) may be further configured to output haptic feedback to the user input device based on the determined position of the virtual instrument. The haptic feedback may comprise vibration.

In some embodiments, the virtual instrument may be prevented from moving outside of a plane of the virtual training model after insertion into the virtual training model. The system (e.g., processor) may be further configured to cause the display device to display an alert when the user input device is moved a threshold distance from the plane of the virtual training model.

In some embodiments, the virtual training model may show one or more internal anatomical structures in a training mode. The virtual training model may not show any internal anatomical structures when not in the training mode.

In some embodiments, the user input device may be configured to receive a user input for simulating a pulse from the virtual instrument. The system (e.g., processor) may be further configured to generate the one or more simulated bioelectrical responses based on the position of the virtual instrument when the user input was received. In some embodiments, the systems (e.g., processor) disclosed herein may be further configured to cause the display device to display a checklist showing one or more steps for the training.

### BRIEF DESCRIPTION OF THE DRAWINGS

Several features of the disclosure are set forth with particularity in the claims. A better understanding of the features and advantages of various embodiment can be obtained by reference to the following detailed description that sets forth illustrative non-limiting embodiments, in which the principles of the disclosure are utilized, and the accompanying drawings described below. Features from one figure may be combined with features of other figures.

FIG. 1 illustrates a block diagram of a neuromodulation surgical training system, according to some embodiments..

FIG. 2 illustrates a physical training apparatus of the neuromodulation surgical training system, according to some embodiments.

FIG. 3 illustrates a monitoring unit of the neuromodulation surgical training system, according to some embodiments.

FIG. 4 illustrates a display of the neuromodulation surgical training system, according to some embodiments.

FIGS. 5A-5C illustrate example displayed x-ray images in different three-dimensional orientations of the training apparatus, embodiments of which are disclosed herein.

FIG. 6 is a flowchart illustrating a process of training a user for an electrode lead implantation using some embodiments of the neuromodulation surgical training system disclosed herein, according to some embodiments.

FIG. 7 illustrates an example insertion of a stimulating needle into a physical training apparatus, according to some embodiments.

FIG. 8 illustrates an example of user feedback of some embodiments of the training system disclosed herein comprising a simulated x-ray view of the training apparatus and the position of the stimulating needle.

FIG. 9 illustrates another example of user feedback of some embodiments of the training system disclosed herein comprising one or more EMG responses outputted by a monitoring unit.

FIG. 10 illustrates a block diagram of a neuromodulation surgical training system having a virtual or augmented environment, according to some embodiments.

FIG. 11 illustrates a user input device of some embodiments of a neuromodulation surgical training system described herein having a virtual or augmented environment.

FIG. 12 illustrates a virtual training target and virtual instrument of some embodiments of the neuromodulation surgical training system disclosed herein.

FIG. 13 illustrates a virtual training module of some embodiments of the neuromodulation surgical training system disclosed herein.

FIG. 14 illustrates a virtual x-ray and virtual monitoring unit provided by some embodiments of the neuromodulation surgical training system disclosed herein.

FIG. 15 illustrates an example of visual feedback during a simulated training procedure displayed by some embodiments of the neuromodulation surgical training system disclosed herein.

FIG. 16 illustrates another example of a visual feedback during a simulated training procedure displayed by some embodiments of the neuromodulation surgical training system disclosed herein.

### DETAILED DESCRIPTION

Neuromodulation systems and methods may involve stimulation of specific areas of the nervous system to alter nerve activity. One type of stimulation may comprise electrical stimulation. Electrical stimulation has clinical application in providing treatment and/or management of a variety of clinical conditions, for example within the pelvic region. For example, electrical stimulation may be used to treat urinary incontinence (such as urge, stress or mixed urinary incontinence), fecal incontinence, pain, sexual dysfunction, or any combination thereof medical condition and/or diseases within the pelvic region. Electrical stimulation is often delivered to a target nerve via one or more electrodes on an electrode lead. Electrode leads may be implanted at one or more target tissue and/or anatomical features, for example in the pelvic region, to provide treatment and/or management electrical stimulation. The effectiveness of electrical stimulation therapy may depend greatly on the proper placement of the implanted electrode leads at a target nerve site. For example, the target nerve may comprise a pudendal nerve and/or a sacral nerve.

Traditional training on cadavers may be effective for training of many surgical techniques, however, for neuromodulation or neurostimulation surgical techniques, the lack of bioelectrical responses and potential soft tissue differences between the frozen specimen and living tissue makes training on cadavers less than ideal. In addition, there are logistical challenges in securing specimens and labs, surgeon travel and availability, associated costs, limited usage per specimen, and unnecessary x-ray exposure. There have also been efforts to limit the use of human specimens. Thus, systems and methods for effectively training the surgical implantation of the electrode leads is needed. For example, an artificial training model for neuromodulation or neurostimulation surgical techniques may be both practical and far more flexible. However, even current anatomical models do not replicate the radiopacity of a bony pelvis nor come with an integrated nerve.

The devices, systems, methods, and/or kits described elsewhere herein, provide a solution to train a user to implant an electrode lead at a target implantation location. The user may be a surgeon and/or other medical personnel. The devices, systems, methods, and/or kits, as described elsewhere herein, may comprise a physical training apparatus configured to simulate the anatomy of the target implantation area, an elongate medical instrument for insertion into the training apparatus, and one or more sensors configured to aid in determining the position of the instrument within the training apparatus. The devices, systems, methods, and/or kits, as described elsewhere herein may comprise one or more processors configured to determine the position of the instrument based readings from the one or more sensors. The processor(s) may also be configured to provide feedback to the user during the training process based on the determined location and/or cause a display device to display a view of the anatomy, e.g., an x-ray view, computer generated image or animation, MRI images, CT images, ultrasound images, or images from any other medical imaging device. The devices, systems, methods, and/or kits, as described elsewhere herein may further comprise a monitoring unit configured to provide feedback to the user during the training to simulate the responses, e.g., EMG and/or pressure responses, of a live patient during an actual surgical procedure. The training systems and methods disclosed herein may provide users with a robust and realistic simulation of the expected surgical environment and procedure in order to familiarize themselves with the x-ray landmarks, instrumentation and implants, the requisite physical steps, and the key feedback at different decision points during a surgical procedure.

The devices, systems, methods, and/or kits described elsewhere herein, provide a solution to train a user to implant a treatment device to treat incontinence. Incontinence, including a lack of control over micturition or bowel movements, has many causes but may involve injury or weakness of the pelvic floor muscles and the nerves that innervate these muscles and involved organs. Several embodiments described herein provide systems and methods for training a user to implant a treatment device to treat various conditions, such as urinary incontinence, fecal incontinence, pain, sexual dysfunction, or any combination thereof medical condition and/or diseases within the pelvic region. In some embodiments, the pelvic condition includes urinary incontinence, fecal incontinence, pain, sexual dysfunction, or any combination thereof. Although several embodiments are described herein with respect to the pelvic region to treat and/or manage pelvic conditions, they may also be used in other regions of the body or to treat other conditions as described elsewhere herein. With respect to urinary incontinence, the treatment device may treat one or more types of incontinence (e.g., urge, stress, mixed).

Although certain devices, systems, methods, and kits are described herein with respect to the pelvic region to train neuromodulation surgical techniques within the pelvic area, the methods and devices can be used to train surgeons and/or other medical personnel in other regions of the body or for treating other conditions. In some embodiments, the disclosed training systems and methods may be used for training of any type of peripheral nerve stimulation. In some embodiments, the training system may be used for training the implantation of electrode lead bodies in the spinal region, for example to treat chronic or incidental pain. In other embodiments, the training system may be used to train implantation of electrode lead bodies near peripheral or cranial nerves. For example, the training system may be used to train implantation of an electrode lead body near the vagus nerve (e.g., in the facial/cranial region) for treatment of several disorders, including but not limited to balance issues, headache, migraines, etc. In some embodiments, the training system may be applied to surgical techniques involving implantable devices used outside of the field of neuromodulation. In some embodiments, the training system may be applied to surgical techniques using non-implantable or acute devices such as catheters, e.g., drug delivery catheters or drainage catheters, or other medical devices having an elongate structure.

In some embodiments, the devices, systems, methods, and/or kits provided herein may be specific to training of a neuromodulation surgical technique associated with a pelvic nerve, e.g., one or more of a pudendal nerve, sacral nerve, tibial nerve, etc. In some embodiments, the devices, systems, methods, and/or kits provided herein may be specific to training of a neuromodulation surgical technique associated with one or more nerves associated with incontinence, including but not limited to urinary incontinence (such as urge, stress or mixed urinary incontinence), overactive bladder, fecal incontinence, etc. Some embodiments are particular well suited for training of tissue (e.g., nerve) targeting in the pelvic region because, for example, pelvic nerves may have an increased level of difficulty for surgeons to locate and place a device, such as an electrode lead, adjacent to, because of the complicated anatomical structures and the tortuous pathways followed by the nerves.

Some embodiments described herein are focused on procedures for the pelvic region, and exclude other regions, and thus the features and steps disclosed herein consist essentially for pelvic region training. In one embodiment, the devices, systems, method, and/or kits provided herein are not used for training of procedures in one or more of the following spine; facial, skull/brain regions. In one embodiment, the devices, systems, method, and/or kits provided herein are not used for training of nerve block procedures (and instead are used for nerve stimulation procedures).

In some embodiments, the devices, systems, methods, and/or kits provided herein may be specific to training of a neuromodulation surgical technique associated with one or more of a pudendal, sacral, tibial, pelvic splanchnic, hypogastric, or other nerve influencing bowel or bladder function. In some cases, a placement of an electrode lead at a certain location (e.g. the pudendal nerve) may have a higher difficulty. For example, some portions the pudendal nerve effective for stimulation may be surrounded by muscle, ligaments, and other tissue that cannot be easily visualized. Some portions of the pudendal nerve may be surrounded by various types of anatomical structures, e.g., muscle, ligaments, bone, fat, etc., overlaying each other and each having different levels of hardness and sensitivity. For example, the sacrotuberous ligament surrounding the pudendal nerve is a dense, tough structure that may deflect a needle and impede placement. Thus, it may be beneficial to include feedback, e.g., haptic feedback, in a training system corresponding to different types of anatomical structures. In these embodiments, having multiple views of the anatomy, measuring the responses elicited by stimulation, providing haptic feedback, and/or other benefits associated with training systems disclosed herein, may be of increased importance and/or specific to a pudendal nerve (or other target nerve(s)).

The devices, systems, methods and/or kits provided herein may be compatible with electrophysiological guidance, alone or in combination with radiological guidance, for accurate simulated training of implantation of an electrode lead at a target tissue. The devices, systems, and methods provided herein may allow for more accurate and realistic training for placement of electrodes on the difficult-to-access tissues to adequately train the healthcare professional performing the procedure. Target tissue includes one or a combination of nerves to treat incontinence, pain and/or sexual dysfunction according to some embodiments. In some embodiments, the region being accessed is at least one of the pelvic region, spine and other joints, thoracic region, and the skull/facial region.

In some cases, the proper surgical placement of one or more electrode leads for neurostimulation may be performed and verified using a stimulating instrument (e.g., a stimulating needle, introducer, guidewire) and one or more bioelectrical sensors configured to measure bioelectrical signals, e.g., electromyographic (EMG) signals, electroneurographic (ENG) signals, or electroencephalographic (EEG) signals, etc. For example, the stimulating instrument may be inserted into the patient while outputting electrical stimulation and the bioelectrical responses from the area may be measured. The proper placement of the stimulating instrument may be confirmed once receiving the optimal bioelectrical responses from one or more areas of the body. The stimulating instrument eliciting good or optimal bioelectrical responses may then be removed, and the pathway within the body created by the stimulating instrument may then be followed by the surgeon for implantation of the electrode lead. In some embodiments, the proper surgical placement of the one or more electrode leads may be verified using pressure measurements, e.g., urodynamics and/or anal manometry. In some embodiments, the proper placement may be verified using ultrasound or doppler signals to measure changes in blood flow.

Illustratively, by way of non-limiting example, a user may practice a key step for the implantation of an electrode lead into a target region (including but not limited to a pelvis for treating a pelvic condition). The pelvic condition may comprise urinary incontinence, fecal incontinence, pain, sexual dysfunction, or any combination thereof. The devices, systems, methods, and/or kits described herein may provide surgical training for implantation of components of electrical nerve stimulation systems configured to prevent an episode of incontinence in an individual in need thereof. The training system may comprise a training apparatus in the form of an anatomical model of a pelvis. The anatomical model may be configured to simulate one or more layers of tissue (e.g., skin, muscle, fat, one or more nerves). The simulated one or more layers of tissue may have a uniformly distributed resistance, or each of the one or more layers of simulated tissue may comprise a specific resistance to provide tactile feedback similar to that expected from different layers of tissue in live patients, e.g., fat, muscle, ligaments, fascia, etc. The training system may comprise one or more elongate instruments configured to be inserted into a conductive material included on the training apparatus. The one or more instruments may comprise any of a guide wire, an introducer sheath, a lead position guide (LPG), and/or an electrode lead, or other instrument inserted into a patient throughout the process of implanting an electrode lead. Although certain examples herein may be provided with respect to a stimulating needle, the training apparatus may be used with any of the aforementioned instruments. The simulated procedure may include any of the features of PCT/GB2024/052215, corresponding to International Publication No. WO 2025/040923 A1, filed Aug. 23, 2024, the entire disclosure of which is hereby incorporated by reference in its entirety.

The devices, systems, and methods provided herein may train a user for insertion of the instrument to access the pudendal nerve by an ischiorectal approach. In cases, the ischiorectal approach may comprise the one or more instruments penetrating or passing close to the sacrotuberous ligament and directing the lead to the pudendal nerve trunk at a location proximate to Alcock's canal. The devices, systems, and methods provided herein may train a user for insertion of an elongate instrument to access the pudendal nerve by a low gluteal approach, also referred herein as a low posterior approach. The low gluteal approach may comprise where the instrument passes in a space between sacrotuberous and sacrospinous ligaments and passes anteriorly in the ischiorectal fossa below the pelvic floor. The electrode lead placed using the low gluteal approach may stimulate the anterior branches of the pudendal nerve (including the dorsal genital nerve).

In some embodiments, the training system may be used to train neurostimulation procedures after implantation of the electrode lead. For example, a user may train configuration of an electrode lead for stimulation. An electrode lead may comprise one or more electrodes, for stimulation and/or sensing. The user may configure each of the electrodes on one or more implanted electrode leads to stimulate or sense. The training system may be used to test various electrode configurations for one or more implanted electrode leads in the training system to measure the responses from the stimulation. The training system may measure one or more bioelectrical responses to provide feedback on the effectiveness of the stimulation based on the electrode configuration. In another example, the training system may be used to test various stimulation parameters used for the one or more electrode leads implanted in the training system. The training system may measure one or more bioelectrical responses to provide feedback on the effectiveness of the stimulation based on the stimulation parameters.

### Physical Training Apparatus

Provided herein are devices, systems, and methods for training a user for implanting an electrode lead at one or more target tissues, for example within the pelvic region. The target tissue may comprise tissue adjacent to a target nerve (e.g., pudendal nerve or sacral nerve) to treat incontinence. The target tissue may comprise a target tissue to receive electrical stimulation for sexual dysfunction. The target tissue may comprise a target tissue to receive electrical stimulation for pain treatment and/or management. Although certain devices, systems, methods, and/or kits are described herein with respect to training a user within the pelvic region, the systems, methods, devices, and/or kits can be used in other regions of the body or to train users for surgical techniques used for treating other conditions as described elsewhere herein. In some embodiments, the devices, systems, methods, and/or kits may be used to train users for surgical techniques performed in or near the spine to treat, for example, pain. In some embodiments, the devices, systems, methods, and/or kits may be used to train users for surgical techniques performed in or near the cranial region to treat, for example, headaches, migraines, etc. In some embodiments, the devices, systems, methods, and/or kits disclosed herein may be used to train users only for surgical techniques performed in the pelvic area, but not for those performed in or near the spine and other joints, thoracic, or the cranial/facial region.

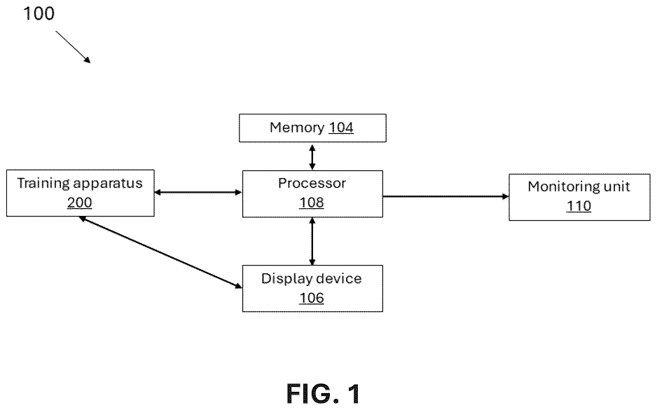

FIG. 1 shows a network diagram of an example embodiment of a neuromodulation surgical training system 100. The neuromodulation surgical training system 100 includes a training apparatus 200 that is configured to receive an elongate medical instrument. The instrument may comprise any insertion instrument configured to create a pathway within a patient, such as a needle, trocar, obturator, or the like. The instrument may be configured to output electrical stimulation (sometimes referred to herein as a “stimulating instrument”). The training apparatus 200 may be configured to model a portion of human or animal anatomy and may also be referred to as a training model 200. The training apparatus 200 may be configured to communicate directly with a display device 106. In some embodiments, the training apparatus 200 may communicate with the display device 106 via a network. The network may include one or more networking technologies (e.g., satellite, LAN, WAN, cellular, peer-to-peer, etc.). The network may be a public network (e.g., the Internet), or a private network (e.g., a virtual private network, also referred to as a “VPN”). The messages communicated via the network can be transmitted and/or received using appropriate and known network transmission protocols (e.g., TCP/IP). The display device 106 may comprise an electronic communication device configured for wired or wireless network communications. The display device 106 may include a visual display such as a touchscreen, monitor, display screen, or the like.

The training system 100 may include a processor 108, which may execute software or instructions stored on a non-transitory computer readable storage medium to implement the described features. The training apparatus 200 and display device 106 may communicate directly, or via a network, with the processor 108. The processor 108 may be a microprocessor. Illustratively, the processor 108 may include one or more processors, without limitation, two or more processing cores on a single processing chip, two or more separate processor chips, or both. In some embodiments, the processor 108 can also include one or more additional or specialized processors such as, for example, a graphics processor, to perform graphics processing functions that can be diverted from one or more main processors to improve performance and/or to relieve their workload. The processor 108 may store and retrieve information from a memory device 104 for recording and storing data, such as x-ray images and EMG data. The processor 108 may further include hardware and/or software modules for determining a position of the instrument within the training apparatus 200 and generating feedback based on the determined position. The processor 108 may further include hardware and/or software modules for analyzing readings from an array of one or more sensing electrodes, and/or other sensors described elsewhere in the present disclosure. The processor 108 may be further configured to cause a display device 106 to display an image of the anatomy modeled by the training apparatus 200 and/or the position of the instrument within the anatomy of the training apparatus 200. The processor 108 may communicate directly, or via the network, with a monitoring unit 110. The processor 108 may be configured to cause the monitoring unit 110 to output one or more bioelectrical responses based on the determined position of the instrument.

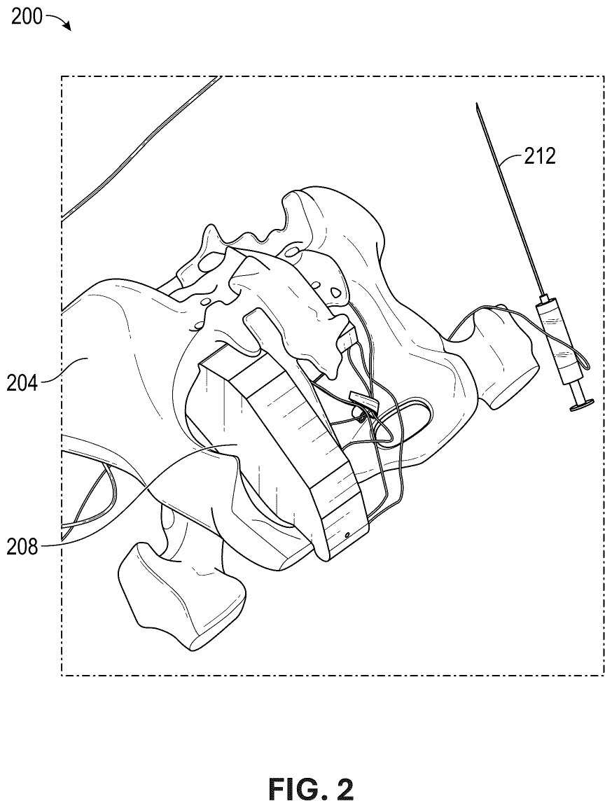

FIG. 2 depicts the use of a training apparatus 200 used for neuromodulation surgical training. The training apparatus 200 can be used to train any type of surgical technique involving insertion of an elongate instrument into a patient to create a pathway for proper placement of a neuromodulation instrument within the body. The trained surgical technique may be used for permanent implantation of a neuromodulation system. In some cases, the trained surgical technique may be used for temporary implantation of a neuromodulation system. The elongated instrument may be configured to output electrical stimulation. For example, surgical training may be provided for insertion of a stimulating needle 212 into the pelvic area of a patient. The stimulating needle may be used to create a pathway for implanting a electrode lead at a target nerve, such as a pudendal and/or sacral nerve. The training apparatus 200 may anatomically model a pelvis of a human or animal. Although not shown in the accompanying drawings, the training apparatus can model other target sites for neuromodulation including the chest, head, arms, legs, back, etc. The training apparatus 200 may also represent any body part of a human or animal, including internal organs. For example, the training apparatus 200 may comprise simulated bone, layers of soft tissue, muscle, fat, fibrous ligaments, nerves, etc.

The training apparatus 200 may comprise simulated bone 204. The simulated bone 204 may comprise a high density material. The simulated bone 204 may comprise a thermoplastic material. For example, the simulated bone 204 may comprise nylon, acrylonitrile butadiene styrene (ABS), polyurethane, or another similar polymer of high density. In some embodiments, the simulated bone 204 may comprise hydroxyapatite (HA). The simulated bone 204 may be reinforced with epoxy or a similar material. The simulated bone 204 may be a 3D printed material. The simulated bone 204 may be manufactured by additive 3D printing, laser cutting, injection molding, or a combination thereof. The additive 3D printing may comprise selective laser sintering. The simulated bone 204 may be radiopaque such that the simulated bone 204 of the training apparatus 200 may be visible on an x-ray. For example, the simulated bone 204 may be constructed from a radiopaque material and/or include a radiopaque filler or additive, e.g., barium sulfate, bismuth compounds, or tungsten. Some areas of the simulated bone 204 may comprise indicia to indicate a key bone landmark of the surgical technique being trained. The indicia may include a marking, recess, dimple, color, LED light, etc.

As shown in FIG. 2, the training apparatus 200 comprises a simulated bone 204 in the form of a pelvis and the greater trochanters of the femurs. The simulated bone 204 of a pelvis may include, without limitation, portions simulating the anatomical structure of the ilium, sacrum, coccyx, ischium, and pubis bones. The simulated bone 204 may not be a completely accurate representation of the bone it is meant to simulate. The simulated bone 204 may include one or more portions that also serve as a grip for the user. For example, the simulated bone 204 shown in FIG. 2 includes the greater trochanters of the femurs, which may be gripped by the user when rotating or moving the training apparatus 200. In another example, the ilium of the simulated bone 204 may comprise a gripping portion for a hand of the user. The simulated bone 204 may comprise a recess or depression configured to hold one or more sensors, e.g., a gyroscope, as discussed elsewhere in the present disclosure.

The training apparatus 200 may comprise one or more layers of material for simulating tissue disposed along the simulated bone. The tissue simulating material may be permanently attached, removably attached, or unsecured to the simulated bone. In some cases, the tissue simulating material may be contoured to the simulated bone. The tissue simulating material may comprise a polymeric material. Additionally, or alternatively, the tissue simulating material may comprise a conductive material. For example, as shown in FIG. 2, the training apparatus 200 may comprise one or more layers of a conductive foam 208. The conductive foam 208 may be suitably dense for simulating the tissue within the pelvis. The conductive foam 208 may be configured to simulate the operative tissue for which a stimulating instrument is to be inserted. The conductive foam 208 may be placed over the operative area of the training apparatus 200. For example, as shown in FIG. 2, the conductive foam 208 may be placed between the ischial tuberosity and the ischial spine of the simulated bone 204 in the form of a pelvis. The conductive foam 208 may comprise a suitably dense material to provide haptic feedback as the stimulating instrument is inserted into the foam. The conductive foam 208 may comprise a base foam material mixed with a conductive material, e.g., carbon. The base foam material may comprise polymers such high-density polyethylene (HDPE), fluorinated ethylene propylene (FEP), polycarbonate, plastics, or any combination thereof. The conductive foam 208 may comprise an array of one or more electrodes in electrical contact with the conductive foam 208, as discussed elsewhere in the present disclosure. The conductive foam 208 may be placed on or within the simulated bone 204 by shape matching the inner surface of the bone 204 to laser-cut contours in the conductive foam 208. The conductive foam 208 may be secured to the simulated bone 204 by adhesive, hook and loop, screws, or other similar securing means known in the art. The conductive foam 208 may be detachable from the simulated bone 204, e.g., using hook and loop or screws. In some embodiments, the conductive foam 208 may be permanently attached to the simulated bone 204, e.g., using an adhesive or welding.

In some embodiments, the conductive foam 208 may comprise a low density material. In some embodiments, the one or more layers of conductive foam 208 may comprise varying densities depending on the tissue the foam is meant to stimulate. In some cases, different layers of the conductive foam 208 may have a density such that the foam is configured to simulate a certain type of tissue, e.g., fibrous ligament, muscle, fat, etc. In some cases, areas of the conductive foam 208 near or adjacent to the simulated bone 204 may comprise a relatively higher resistance material to provide haptic feedback to the user. For example, a higher resistive force provided by the areas of the foam adjacent to the simulated bone may be felt by a user inserting the stimulating instrument, indicating that the tip of the stimulating instrument is nearing a bone area.

Additionally, or alternatively, the training apparatus 200 may comprise one or more layers of synthetic tissue. The different layers of synthetic tissue may be configured to simulate different layers of representative tissue, e.g., skin, tough fibrous ligaments, subcutaneous fat, muscle, etc., within the anatomical area modeled by the training apparatus 200. The synthetic tissue may provide haptic feedback such as force feedback, depth feedback, or tactile feedback. The haptic feedback may be beneficial to simulate the forces felt by a surgeon inserting a stimulating instrument into a live patient. For example, the surgeon may feel a higher resistive force when inserting the stimulating instrument through a layer of fibrous ligaments than the resistive force felt when inserting through a layer of fat and/or a layer of skin. The force feedback may comprise a resistive force provided by the material of the layer of synthetic tissue when pushing an instrument through the specific layer and felt by the user. The different layers of synthetic tissue may have different appearances, textures, or resistances that are representative of the specific tissue type the layer is meant to simulate. For example, a synthetic fat tissue layer may comprise a different resistance, color, texture, pattern, etc., than a synthetic muscle tissue layer. In some embodiments, the training apparatus 200 in the form of a pelvis may comprise synthetic tissue to simulate the gluteal mass. The synthetic tissue may be configured to replicate the electrical conductivity of the representative tissue of the body. Thus, the synthetic tissue may be used in conjunction with the training apparatus. In some embodiments, the synthetic tissue may be used in place of the conductive foam as the only conductive material.

The training apparatus 200 may comprise one or more target nerves. The target nerve may comprise a target location within the training apparatus 200 that is representative of where the nerve would be located in the representative anatomy. For example, the target nerve may be a portion of the conductive foam 208 that would represent the location of the pudendal nerve relative to the simulated bone 204. In some embodiments, the target nerve may be a physical structure that simulates nerve tissue within the training apparatus 200. For a training apparatus 200 modeling a pelvic area, the target nerve may comprise one or more of the pudendal nerve, tibial nerve, peroneal nerve, sacral nerve, cauda equina, pelvic parasympathetic nerves, lumbar sympathetic nerves, and/or nerve branches leading to and from such nerves. However, for a training apparatus modeling a different part of anatomy, the target nerve may be a nerve for which neuromodulation thereof can have some therapeutic effect.

The neuromodulation surgical training system 100 may comprise an elongate medical instrument. The instrument may comprise or take the form of any surgical instrument configured to penetrate one or more layers of tissue of a patient. The instrument may hereinafter be described as a needle. However, in some cases, the instrument may be any insertion instrument used to create a pathway within a patient, such as a trocar, an obturator, an introducer, a positioning guide, a lead, or the like. The needle may be configured to penetrate the conductive foam 208 and/or the synthetic tissue of the training apparatus 200. The needle may comprise one or more sensors configured to obtain sensor information associated with one or more characteristics of the needle as it is being used to deliver electrical stimulation. For example, the needle may comprise a motion or position sensor, an optical sensor, a magnetic sensor, a light sensor, a force sensor, or some combination thereof, etc., configured to aid in determining the position of the needle within the training apparatus 200. In some embodiments, the needle may comprise one or more infrared markers. The needle may comprise one or more radiopaque markers. The needle may be a stimulating needle configured to output one or more levels of electrical stimulation. The stimulating needle may be configured to output the stimulation at a single point of the needle, e.g., the tip. In some embodiments, the stimulating needle may be configured to output stimulation at a plurality of points on the needle. The stimulation outputted at the plurality of points on the stimulating needle may be simultaneous or alternating. The stimulating needle may be connected to an external stimulator. The stimulator may provide about 6 mA or less of current to the stimulating needle. The stimulator may provide a current of about 1 mA, 2 mA, 3 mA, 4 mA, 5 mA, or 6 mA. To simulate a live surgical procedure, the stimulating needle may elicit one or more simulated bioelectrical responses while being inserted into the training apparatus 200 to indicate when the needle is close to the target nerve of the training apparatus 200. For example, the stimulating needle may elicit simulated EMG responses from the pelvic floor and/or external anal sphincter to indicate the needle has reached a target pudendal nerve in the training apparatus 200.

As shown in FIG. 2, the neuromodulation surgical training system 100 may comprise a stimulating needle 212. The stimulating needle 212 may be configured to penetrate the conductive foam 208. The stimulating needle 212 may comprise a distal tip, an elongated body, and a proximal portion. The stimulating needle 212 may comprise a Chiba, trocar or other needle tip. The stimulating needle 212 may be configured to output electrical stimulation at the distal tip of the needle. The elongate body of the stimulating needle 212 may be insulated along an entire length of the elongate body such that the stimulation is only output at the distal tip. In some embodiments, the needle may include one or more electrodes at or near the distal tip to output the stimulation. The one or more electrodes may span the entire outer circumference of the needle body. In some embodiments, the one or more electrodes may span only a portion of the circumference of the needle body to provide targeted stimulation. The proximal portion of the stimulating needle 212 may comprise a handle or other structure configured to be held or gripped by the user. In some embodiments, the distal tip of the stimulating needle 212 may be angled from the elongate body of the needle. The stimulating needle 212 may be the same type of needle used in the live patient surgical technique. In some embodiments, the stimulating needle 212 may be a specially adapted instrument for use with the training apparatus 200. The stimulating needle 212 may comprise one or more sensors, e.g., motion, position, bioelectrical, pressure, or force sensors. The one or more sensors may be configured to aid in determining the position of the stimulating needle 212 within the conductive foam 208. In some embodiments, the stimulating needle 212 may comprise one or more infrared or radiopaque markers. In some embodiments, the stimulating needle 212 may comprise radiopaque additives. The stimulating needle 212 may have a diameter of about 0.1 mm to about 2 mm. The stimulating needle 212 may or may not have an inner lumen. The stimulating needle 212 may have a length between 100 and 400 mm, for example, between 100 and 150 mm, between 150 and 200 mm, between 200 and 250 mm, between 250 and 300 mm, between 300 and 350 mm, between 350 and 400 mm, or a length in a range defined by any of these values.

The training apparatus 200 may comprise one or more sensors placed on or within the tissue simulating material, e.g., foam or synthetic tissue. In some embodiments, the one or more sensors may comprise an external sensor, e.g., a camera. The one or more sensors may collect data used for determining a position of the instrument, e.g., stimulating needle 212, inserted into the training apparatus 200. The one or more sensors may comprise optical sensors, magnetic sensors (e.g., for generating or detecting an electromagnetic field), acoustic sensors, etc. In some embodiments, the one or more sensors may be configured to measure a parameter, e.g., resistance, current, capacitance, voltage, etc., associated with electrical stimulation from a stimulating needle. For example, the training apparatus 200 may comprise an array of one or more electrodes placed on or within the conductive material, e.g., conductive foam 208. The array of one or more electrodes may comprise sensing electrodes configured to measure electrical signals. The electrodes may be configured to sense electrical signals outputted by the stimulating needle 212. The readings from the array of electrodes may be used to calculate a position of the tip, or other stimulating portion, of the stimulating needle 212. For example, an increased voltage reading measured by one electrode may indicate that the tip of the stimulating needle 212 has moved closer to that electrode. In another example, a higher voltage reading at a first electrode compared to a second electrode may indicate that that the tip of the stimulating needle 212 is closer to the first electrode than the second electrode. The array of one or more electrodes may be pre-calibrated such that the readings from any particular electrode may be used to estimate a distance of tip of the stimulating needle 212 to that electrode. The data from the array of one or more electrodes may be received by the processor 108 of the training system 100. The processor may be configured to determine a position of the stimulating needle 212 based on the data from the array of one or more electrodes. The processor may be configured to calculate a relative position of the stimulating needle 212 within the training apparatus 200 based on the measured signals and/or changes in the measured signals of each of the array of electrodes. For example, a position of the stimulating needle 212 may include a depth of the stimulating needle within the conductive material. The processor 108 may be configured to determine a live position of the stimulating needle 212 within the training apparatus 200. Additionally, or alternatively, the processor 108 may store the readings from the array of one or more electrodes in the memory 104 and use the stored data to determine an insertion pathway followed by the stimulating needle 212 within the training apparatus 200. In some embodiments, the processor 108 may be configured to calculate a relative position and/or insertion pathway of the stimulating needle 212 based on data from the array of electrodes in conjunction with data from one or more additional sensors on the stimulating needle 212 and/or the training apparatus 200, e.g., positional sensors. In some embodiments, the processor 108 may use machine learning and/or artificial intelligence algorithms trained on a dataset to determine the position of the stimulating needle 212 based on the sensor data.

The one or more electrodes of the array of electrodes may be placed at various positions within the conductive material, e.g., conductive foam 208. The array of electrodes may be placed only at or around a predetermined insertion pathway within the conductive material. The predetermined insertion pathway may lead to the target nerve in the training apparatus 200, e.g., a pudendal and/or sacral nerve, or adjacent the target nerve. For example, the predetermined pathway may comprise an ischiorectal approach or a gluteal approach for pudendal nerve stimulation, as discussed elsewhere in the present disclosure. In some embodiments, the one or more electrodes of the array may be uniformly distributed or almost uniformly distributed within the conductive material. In some cases, only a portion of the one or more electrodes in the electrode array may be active during a training procedure, while the remaining portion of electrodes are deactivated. The portion of active electrodes may represent electrodes following the desired insertion pathway specific to the training procedure to be performed. Thus, the training apparatus 200 may allow for training of different approaches within the same anatomical area based on user preference. In some embodiments, the one or more electrodes in the array may be divided into groups. The measurements collected from each group of electrodes may be used for providing different responses, as discussed elsewhere with respect to the monitoring unit 110. For example, measurements from a first group of electrodes may be used for outputting simulated EMG responses, while the measurements from a second group of electrodes may be used for outputting simulated pressure responses.

In some embodiments, the training apparatus 200 may comprise one or more alert sensors on one or more anatomical structures simulated by the training apparatus 200. For example, a training apparatus 200 that simulates a nerve may comprise one or more alert sensors on or around a simulated nerve or a location in the apparatus representing the nerve. The one or more alert sensors may comprise a magnetic sensor, a force sensor, etc. The one or more alert sensors may comprise sensing electrodes configured to measure electrical signals. The alert sensors may comprise the same or different electrodes as the electrodes in the array of one or more electrodes used for determining a position of the stimulating needle 212, as described elsewhere herein. The processor 108 may be configured to receive readings from the one or more alert sensors. When the readings of the alert sensor exceeds or falls below a predetermined threshold, the processor 108 may be configured to output feedback to alert the user that the stimulating needle 212 is too close to a simulated component (or representative location) in the training apparatus 200 that the user would want to avoid contact with, e.g., a nerve or an internal organ. The feedback may comprise a vibration from the stimulating needle 212 and felt by the user, a user notification displayed on the display device 106, or auditory feedback. For example, if the voltage readings from an alert sensor comprising a sensing electrode exceed a threshold voltage, the processor 108 may cause the display device 106 to display a warning.

The training system 100 may be configured to output feedback to the user during training representative of one or more responses from a live patient during an actual surgical procedure. In some cases, the training system 100 may comprise a monitoring unit 110. The monitoring unit 110 may be configured to provide the feedback to the user during training. For example, the feedback provided by the monitoring unit 110 may be representative of one or more bioelectrical responses from a live patient during an actual surgical procedure. The monitoring unit 110 may comprise one or more electronic communication devices configured for wired or wireless network communications. For example, the monitoring unit 110 may comprise an intraoperative neuromonitoring (IONM) unit. In another example, the monitoring unit 110 may include a computer or a laptop. The monitoring unit 110 can include any type of display useful to a user, such as, for example, a tablet, phone, laptop or desktop computer, television, projector, or any other electronic based display technology. The monitoring unit 110 may include a visual display such as a touchscreen, monitor, display screen, or the like. The feedback may indicate to the user that they have correctly performed the training procedure, or that they need to adjust and/or restart the procedure. In some embodiments, the monitoring unit 110 and the display device 106 may share the same hardware architecture and/or display. For example, the processor 108 may communicate with a laptop, computer, phone, or other electronic device, which serves as both the display device 106 and the monitoring unit 110, as described herein.

The feedback provided by the monitoring unit 110 may comprise one or more simulated responses of a patient. For example, the monitoring unit 110 may be configured to output and display bioelectrical responses, e.g., EMG responses, based on the determined position of a stimulating needle 212 within the training apparatus. Additionally, or alternatively, the feedback may comprise one or more simulated pressure responses of a patient based on the determined position of the stimulating needle 212. For example, the one or more simulated pressure responses may comprise responses from the lower urinary tract (urodynamics) and/or responses from the anorectal canal (anal manometry). The monitoring unit 110 may allow the user to observe the simulated EMG and/or pressure responses representative of a live patient as the user progresses with inserting the stimulating needle 212 into the training apparatus 200. The monitoring unit 110 may be configured to communicate with the processor 108 directly, or through a network, and receive an instruction to output a specific response based on the determined position of the stimulating needle 212. For example, the instructions to output simulated bioelectrical and/or pressure responses may be pre-programmed for different positions of the stimulating needle 212 within the training apparatus 200. The simulated bioelectrical and/or pressure responses may be based on a dataset of actual observed responses in a live patient at different positions of a stimulating needle. In some embodiments, the processor 108 may use machine learning and/or artificial intelligence to determine the appropriate bioelectrical and/or pressure response output based on the determined position of the stimulating needle 212. For example, a machine learning algorithm may be trained on a dataset of observed EMG or bladder pressure responses in live patient(s) with a stimulating needle at various positions within the patient(s). In some cases, the monitoring unit 110 may output feedback comprising simulated ultrasound images showing changes in blood flow.

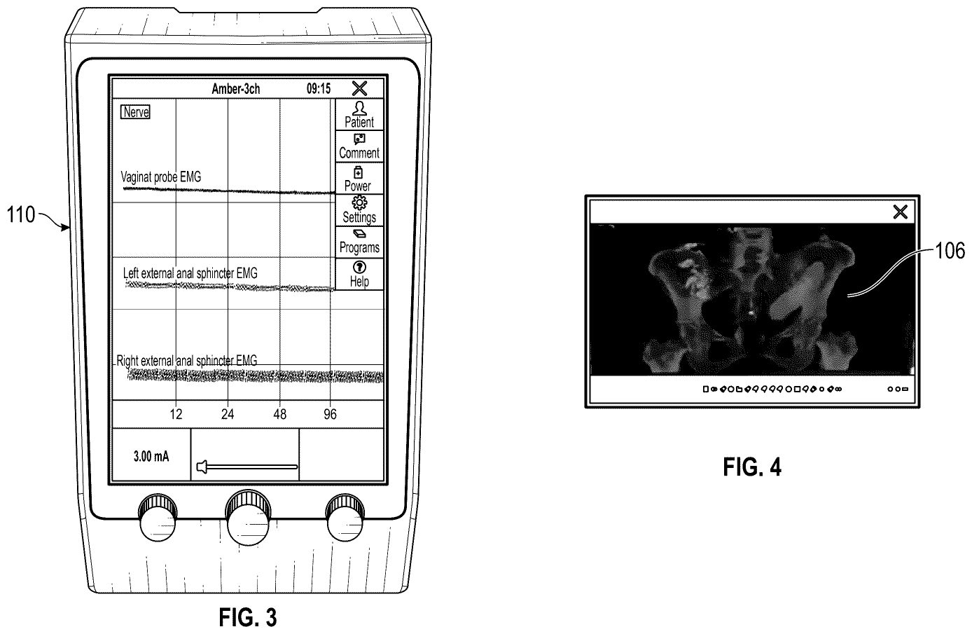

In an illustrative, non-limiting example of a training system for neuromodulation surgical techniques in the pelvic area, the monitoring unit 110 may be configured to output simulated EMG responses (e.g., waveforms) from the pelvic floor and/or the external anal sphincter. In live patients, electrical stimulation of one or more target nerves in the pelvic area may elicit EMG responses from the pelvic floor and/or the external anal sphincter. For example, pudendal nerve stimulation of a live patient may elicit a response in both the external anal sphincter (EAS) and pelvic floor. As shown in FIG. 3, the monitoring unit 110 comprises an external EMG unit configured to output and display simulated EMG responses from the pelvic floor via a vaginal probe, the left external anal sphincter, and the right external anal sphincter. Thus, when the processor 108 determines that the stimulating needle 212 has reached a position within the training apparatus 200 corresponding to a position proximate to the pudendal nerve, the processor 108 may feed the appropriate representative EMG response to the monitoring unit 110, which may include an EMG response in all three of the pelvic floor, left external anal sphincter, and right external anal sphincter.

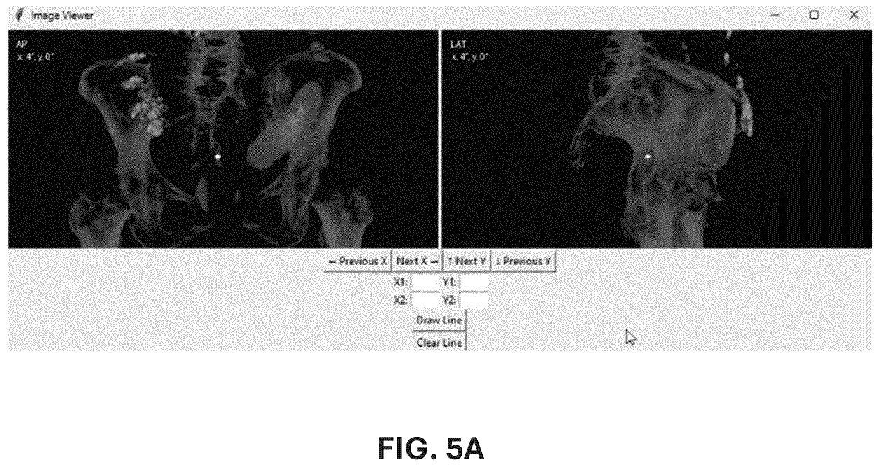

The neuromodulation surgical training system 100 may comprise a display device 106. The display device 106 may comprise an electronic communication device configured for wired or wireless network communications. The display device can include any type of display useful to a user, such as, for example, a tablet, phone, laptop or desktop computer, television, projector, or any other electronic based display technology. The display device 106 may include a visual display such as a touchscreen, monitor, display screen, or the like. The visual display may also be used as an input device, such as a touchscreen. The input device such as a keyboard, keypad, mouse, stylus, camera, biometric sensor, or the like may be coupled with the display device 106 and configured to provide messages to the display device 106. As shown in FIG. 4, the display device 106 may comprise a computer screen, such as a laptop screen. In some embodiments, the monitoring unit 110 and the display device 106 may share the same hardware architecture and/or display. For example, the processor 108 may communicate with a laptop, computer, phone, or other electronic device, which serves as both the display device 106 and the monitoring unit 110, as described herein.

The display device 106 may display a visual depiction of the anatomy modeled by the training apparatus 200. The display device 106 may display a visual depiction of the elongate medical instrument showing the position of the instrument relative to the anatomy and the target location, e.g., the target nerve. The visual depiction may comprise one or more x-ray image(s), or other medical image. In some cases, the visual depiction of the anatomy may comprise a computer-generated three-dimensional model of the anatomy. In some cases, the visual depiction of the anatomy may comprise a computer-generated representation of the internal anatomy, e.g., nerves, fat, muscle, ligaments, etc.

As shown in FIG. 4, the display device 106 may display an x-ray image of the modeled anatomy, e.g., the pelvis. The x-ray image(s) may be of a computer-generated x-ray model of the anatomy. In some embodiments, the x-ray image(s) may comprise a real x-ray image of the anatomy. In some embodiments, the x-ray image(s) may comprise a live x-ray image of the training apparatus 200. Although certain examples are described using x-ray images, the images may also be computer generated image or animation, MRI images, CT images, ultrasound images, or images from any other medical imaging device.

The display device 106 may display x-ray image(s) showing different perspective views of the representative anatomy, e.g., lateral, anterior-posterior, etc., modeled by the training apparatus. The x-ray image(s) may also comprise different three-dimensional (3D) orientational views of the training apparatus anatomy. For example, an x-ray image may comprise a computer-generated 3D x-ray model. In some embodiments, the x-ray image may comprise a real 3D x-ray image from a database stored in the memory 104. The x-ray image(s) displayed in different views and 3D orientations may allow a user to visualize the key bone landmarks for a surgical technique or procedure.

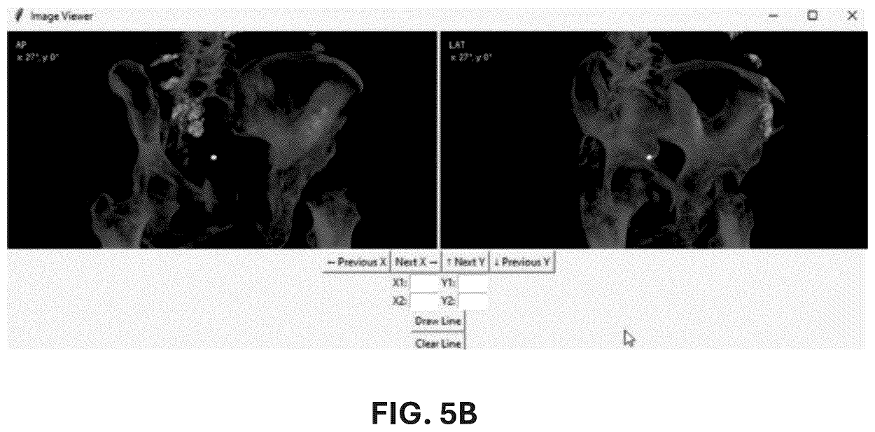

As shown in FIGS. 5A-5C, the display device 106 may be configured to display x-ray image(s) of the training apparatus anatomy, e.g., the pelvis, in an anterior-posterior (AP) view and a lateral view. The different views may be displayed simultaneously, e.g., side by side, as shown in FIGS. 5A-C. The display device 106 may be configured to show x-ray image(s) in any views and in any orientation needed to help the surgeon navigate through the anatomy during the specific procedure.

The training apparatus 200 may comprise one or more position/orientation sensors, e.g., an accelerometer, a gyroscope, and/or a magnetometer. The sensor may be mounted on the training apparatus 200. For example, a gyroscope may be mounted on the sacrum portion of the training apparatus 200. The simulated bone 204 of the training apparatus 200 may comprise a recessed portion configured to hold the one or more sensors to ensure the sensors are not obstructed or damaged during use. The one or more position and/or orientation sensors may communicate directly, or via the network, with the processor 108 and/or the display device 106. The display device 106 may be configured to output an x-ray image corresponding to the measured position and/or orientation of the training apparatus 200 at a specific moment. For example, the processor 108 may receive sensor data indicative of the orientation of the training apparatus 200, determine the orientation of the training apparatus 200, and cause the display device 106 to display an image of the computer-generated 3D x-ray model in the determined orientation. In another example, the processor 108 may receive sensor data indicative of the orientation of the training apparatus 200, determine the orientation of the training apparatus 200, locate a stored real x-ray image in a database with the closest orientational view of the anatomy, and cause the display device 106 to display that x-ray image.

For example, as shown in FIG. 5A, the display output may comprise x-ray images of the pelvis in a side-by-side AP view and a lateral view. The x-ray images shown in FIG. 5A may correspond to when the training apparatus 200 is slightly tilted, e.g., by 4 degrees, in an x-axis of the training apparatus 200. Thus, the real-time measured orientation of the training apparatus 200 may be observed by the user by on the display device 106 displaying the x-ray images in a corresponding orientation. As shown in FIG. 5B, as the training apparatus 200 is rotated further along the x-axis, e.g., to 27 degrees, the display device 106 may display the x-ray images in a corresponding orientation of 27 degrees. As shown in FIG. 5C, the training apparatus 200 may be rotated to the opposite side of the axis, e.g., −19 degrees, and the display device 106 output may mimic the real-time movement of the training apparatus 200. For example, as the training apparatus 200 is moved from an orientation of 27 degrees to −19 degrees, the display device 106 may display x-ray images at various orientations moving between 27 and −19 degrees, until reaching the corresponding orientation of −19 degrees.

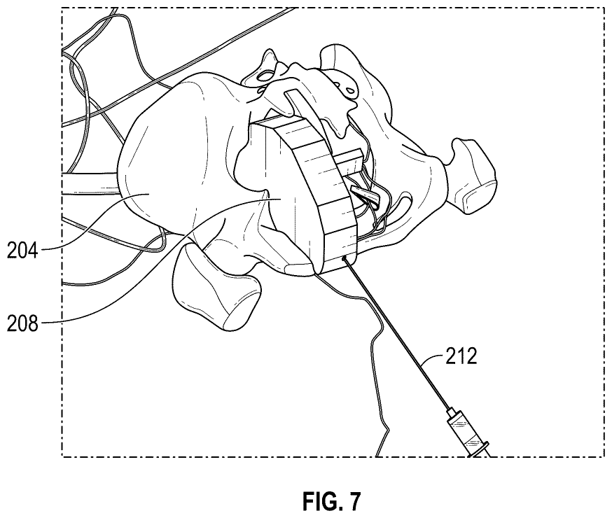

The display device 106 may be configured to display a visual depiction of or representation of an elongate instrument at a position relative to the anatomy of the training apparatus 200. The position of the instrument relative to the training apparatus 200 may be determined by the processor 108 and one or more electrode sensors of the training apparatus, as described elsewhere in the present disclosure. For example, as the stimulating needle 212 is inserted into the conductive foam 208, the position of the stimulating needle 212 may be determined and a visual representation of the stimulating needle may be superimposed onto the x-ray image(s) displayed by the display device 106. In another example, the display device 106 may display an x-ray image comprising a computer-generated x-ray image and a computer-generated depiction of the stimulating needle 212. The display device 106 may show the relative position of the stimulating needle 212 within the anatomy of the training apparatus 200, translated onto the x-ray image(s) with various x-ray landmarks. For example, the display device 106 may show a depth of the stimulating needle 212 within the conductive foam 208, and therefore, the pelvis. As shown in FIG. 8, the display device 106 is displaying an x-ray image of the pelvis and a depiction the stimulating needle 212 at a position in the bottom left of the of the pelvis. The depicted position of the stimulating needle 212 may correspond to the depth at which the stimulating needle 212 has been inserted into the training apparatus 200. In some embodiments, the depiction of the instrument may be shown in the visual representation of the anatomy at a position determined using an array of infrared markers on the instrument which are tracked by an array of cameras configured to detect infrared. In some embodiments, the instrument may be tracked by any other known navigational means employed in surgery and shown on the display output based on the tracked position. In some embodiments, the depicted position of the stimulating needle 212 may be shown in three dimensions relative to a computer-generated three-dimensional model.

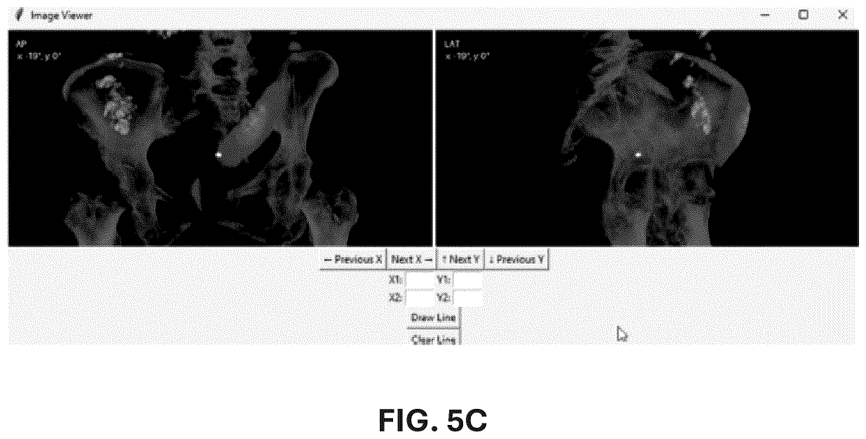

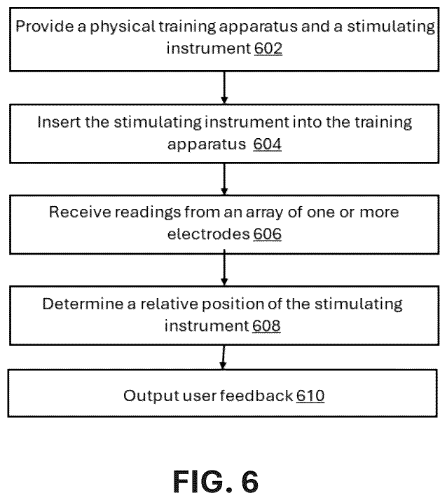

According to embodiments, FIG. 6 illustrates a method 600 of training a user using the neuromodulation surgical training system is disclosed herein. The method may include any of the one or more steps describes below. Any of the steps may be excluded as optional. The method 600 may comprise step 602, providing a physical training apparatus and a stimulating instrument. The physical training apparatus may comprise embodiments of the training apparatus 200 comprising a target nerve, as described elsewhere in the present disclosure. The stimulating instrument may comprise an elongate instrument configured to be inserted into a patient for a variety of surgical techniques and to output one or more levels of electrical stimulation. The stimulating instrument may comprise any instrument used to create a pathway in a patient for implantation of a lead, such as a needle, trocar, obturator, or the like. For example, the stimulating instrument may comprise a stimulating needle used for verification of proper placement of an implantable electrode lead used for electrical stimulation. The method 600 may further comprise step 604, inserting the instrument into the training apparatus. For example, inserting the instrument may comprise inserting a stimulating needle into a conductive material of the training apparatus. As shown in FIG. 7, the stimulating needle 212 may be inserted into the conductive foam 208 of the training apparatus 200. The stimulating needle 212 may be inserted into the training apparatus 200 using an ischiorectal approach, as shown in FIG. 7. In some embodiments, the stimulating needle 212 may be inserted using a lower gluteal approach.

The method 600 may further comprise step 606, receiving readings from an array of one or more electrodes. The one or more electrodes may comprise sensing electrodes configured to sense electrical signals. The array of one or more electrodes may be placed on or within the physical training apparatus. The array of one or more electrodes may be placed along a predetermined and desired insertion pathway for the stimulating instrument. The pathway may lead to the target nerve, e.g., a pudendal nerve and/or a sacral nerve, of the training apparatus 200 modeling a pelvis. The readings may be received by a processor of the training system. The readings may comprise voltage readings from the electrical stimulation outputted by the instrument, e.g., a stimulating needle.

The method 600 may further comprise step 608, determining a relative position of the stimulating instrument. The position of the stimulating instrument may be determined by calculating a distance of a stimulating portion of the instrument, e.g., a tip, to each, or some, of an array of one or more sensing electrodes. The distance of the stimulating portion, e.g., the tip, of the stimulating instrument to an electrode may be calculated using voltage readings from the electrode. The stimulating instrument may deliver a base amount of stimulation that may travel through a conductive material of the training apparatus and to each of the electrodes. The base level of stimulation may have been used to calibrate the one or more electrodes, such that a specific voltage reading of the electrode corresponds to a specific distance of the stimulating instrument to the electrode. Using the calculated distances of the stimulating instrument to each of the one or more electrodes, and since the electrodes are in a fixed position within the training apparatus, the processor 108 may determine a relative position of the instrument to the training apparatus and relative to the target nerve. The processor 108 may determine an insertion pathway followed by the stimulating instrument within the training apparatus, as described elsewhere herein.

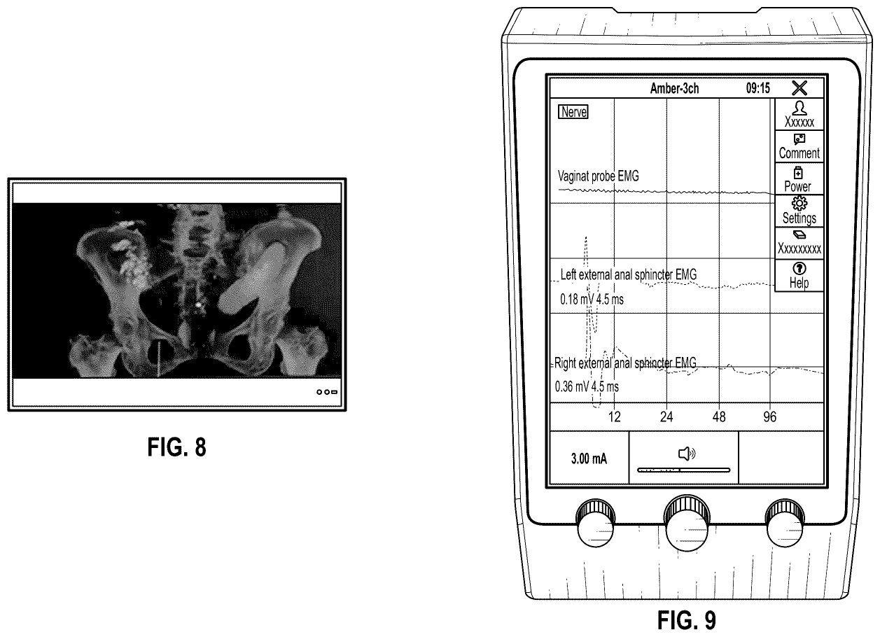

The method 600 may further comprise step 610, outputting user feedback. The user feedback may comprise visual feedback, for example, one or more lights on the training apparatus, x-ray images, or EMG responses. The visual feedback may comprise an x-ray image or computer-generated representation of the anatomy of the training apparatus 200 and a depiction of the stimulating instrument at a relative position to the anatomy, as described elsewhere herein. For example, as shown in FIG. 8, a visual feedback may comprise an x-ray image of the pelvis with an orientation closest to the actual orientation of the training apparatus. The x-ray image may be a real x-ray image or a computer-generated x-ray image. As shown in FIG. 8, the visual feedback may comprise the x-ray image with a superimposed image of the instrument showing the relative position, e.g., a depth, of the instrument within the training apparatus. Additionally, or alternatively, the user feedback may comprise one or more bioelectrical responses, which may be displayed on a monitoring unit, as described elsewhere in the present disclosure. For example, as shown in FIG. 9, a monitoring unit may display one or more simulated EMG responses based on the determined position of the stimulating instrument. The simulated EMG response may be given for one or more target areas where a response to stimulation is desired, such as a pelvic floor and/or a left and right external anal sphincter, in the case of stimulation in the pelvic area. The simulated EMG response may indicate when the stimulating instrument has reached a location proximate to the target nerve in the training apparatus. For example, responses at a pelvic floor and a left and right external anal sphincter may indicate that the stimulating instrument has reached the pudendal nerve. In some embodiments, the user feedback may comprise haptic feedback, such as a vibration of the stimulating instrument. In some embodiments, the user feedback may comprise acoustic feedback.

In several embodiments, the systems and methods described with respect to the physical surgical training system as disclosed herein may be used in conjunction with one or more aspects of the virtual or augmented reality surgical training systems, as described elsewhere in the present disclosure. For example, a surgical training system may comprise a physical training apparatus and physical instrument used in conjunction with an augmented reality environment to display a virtual x-ray and EMG response.

### Virtual or Augmented Reality Training System

Provided herein are devices, systems, and methods for training a user for implanting an electrode lead at one or more target tissues, for example within the pelvic region, within a virtual or augmented environment. Although certain devices, systems, methods, and kits are described herein with respect to training a user within the pelvic region, the methods and devices can be used in other regions of the body or to train users for surgical techniques used for treating other conditions as described elsewhere herein. In some embodiments, the devices and methods may be used to train users for surgical techniques performed in or near the spine to treat, for example, pain. In some embodiments, the devices and methods may be used to train users for surgical techniques performed in or near the cranial region to treat, for example, headaches, migraines, etc.

The disclosed training systems and methods for neuromodulation surgical training with a physical training apparatus may be applied to the training of users in a virtual reality and/or augmented reality environment. The training in a virtual or augmented environment may allow the user to train for the proper placement of implantable electrode leads at a target location, e.g., a target nerve, in a training model. Illustratively, the user can virtually access a portion of the anatomy of interest, such as the pelvis, to simulate creating a pathway to the pudendal nerve. Employing various types of user interface devices such as, for example, handheld controllers configured to operate a virtual elongate instrument, the user can deliver a virtual instrument to a portion of the anatomy of interest and/or simulate the process of stimulating the anatomy of interest to elicit biopotential responses. For example, the user may simulate the process of stimulating the pelvic area to determine whether the EMG responses indicative of proximity to a pudendal nerve are observed, such as pelvic floor and/or external anal sphincter responses. The training system using a virtual or augmented environment may provide the benefit of allowing the user to easily visualize the internal anatomy. Furthermore, the virtual or augmented environment may reduce the amount of physical equipment needed for implementing embodiments of the training system disclosed herein.

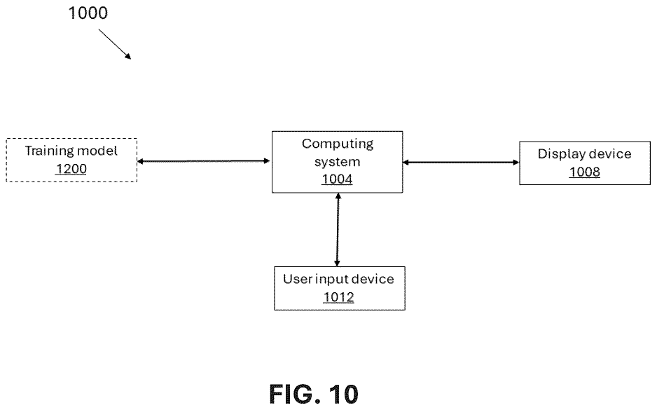

FIG. 10 illustrates an embodiment of neuromodulation surgical training system 1000 configured to generate at least one of a virtual or augmented environment in which a user may be engaged. The training system 1000 may include a computing system 1004, a display device 1008 configured to present visual images of the virtual or augmented environment to the user, and/or a user input device 1012 configured to enable simulation of a surgical technique performed by the user. The neuromodulation surgical training system 1000 may include a virtual training model that may comprise a virtual computer-generated anatomical model. For example, the virtual training model may comprise a virtual anatomical model of the pelvic area of a patient. In these embodiments, the need for physical training models or instruments may be eliminated. This may be beneficial to provide the user more flexibility to train in any environment and reducing the amount of preparation and instrumentation required for the training. However, in some embodiments, the training system 1000 may optionally comprise a physical training model 1200 comprising a physical training apparatus in the form of an anatomical model. For example, the physical training model 1200 may comprise any of the features of the training apparatus 200, as described elsewhere in the present disclosure. Using a physical training apparatus in conjunction with a virtual or augmented environment may be beneficial to provide haptic feedback from a physical model, while also providing visual feedback that may be hard to implement in a purely physical training system.

The display device 1008 may be coupled to the computing system 1004 and configured to present visual images depicting the virtual or augmented environment generated by the neuromodulation surgical training system 1000. The neuromodulation surgical training system 1000 may use information available to a user to provide the user with more complete and accessible information. The information may advantageously result in more informed training procedures and superior outcomes. The neuromodulation surgical training system 1000 may include an integrated network capable of communicating with the computing system 1004, the display device 1008, and/or the user input device 1012. The computing system 1004 may be configured to communicate via the network with the display device 1008 and/or the user input device 1012. The network may include one or more networking technologies (e.g., satellite, LAN, WAN, cellular, peer-to-peer, etc.). The network may be a public network (e.g., the Internet), or a private network (e.g., a virtual private network, also referred to as a “VPN”). The messages communicated via the network can be transmitted and/or received using appropriate and known network transmission protocols (e.g., TCP/IP). In an embodiment, the computing system 1004 can communicate directly with the display device 1008 and/or the user input device 1012. In some embodiments, the computing system 1004 and the display device 1008 may comprise the same hardware architecture. For example, the computing system 1004 may include an integrated display serving as the display device 1008, as described herein.

The disclosed neuromodulation surgical training system 1000 comprises a computing system 1004. The computing system 1004 may include a computing device. The computing device can take one or more of different forms, including, by way of non-limiting examples, a laptop computer, a stand-alone personal computer, a server, a tablet, a workstation, a handheld device, a mobile device (such as a smartphone), and a consumer electronic device (such as a video game console), to name a few. The computing device can be a stand-alone device, or it can be configured to be part of a computing network, a computing cluster, a cloud-based computing infrastructure, or the like.

In a basic configuration, the computing system 1004 can include one or more processors and one or more memory devices. The one or more processors can be configured to execute instructions and to process data to perform one or more functions, such as the methods and the executable instructions stored on computer-readable media disclosed herein. Illustratively, the one or more processors may include, without limitation, two or more processing cores on a single processing chip, two or more separate processor chips, or both. In some embodiments, the computing system 1004 can also include one or more additional or specialized processors such as, for example, a graphics processor, to perform graphics processing functions that can be diverted from the one or more processors to improve performance and/or to relieve their workload. The memory can be arranged in a hierarchy and can include one or more levels of cache. The memory may include one or more memory devices that store data, including without limitation, volatile memory such as random access memory (RAM), non-volatile memory, such as and read-only memory (ROM), flash memory, etc., or a combination of volatile and non-volatile memory.

The computing system 1004 can also include one or more input and output (I/O) connections, such as USB connections, display ports, proprietary connections, and others to connect to various devices to provide inputs and outputs to the computing system 1004. The I/O device(s) may include one or more components that allow a user of the computing system 1004 to interface with applications executing in the computing system 1004. For example, the I/O device(s) may include devices such as a keyboard, a mouse, a touch pad, a touch screen, a microphone, an accelerometer, a camera, or any other user input device configurable to work with the computing system 1004. The I/O device(s) may also include, for example, a display (e.g., an LCD display, a CRT display, an electronic ink display, or a plasma display, to name a few), a printer, a speaker, or any other output devices configurable to work with the computing system 1004.

The computing system 1004 can also include one or more network interface devices that allow the computing system 1004 to communicate with other computers and applications. The one or more network interface devices may include any communication device for sending and receiving data across a network, including, but not limited to, a network interface card, a modem, or another network adapter capable of transmitting and receiving data over a network. Communication protocol connections can include, without limitation, an Ethernet interface, a wireless interface, a bus interface, a storage area network interface, and a proprietary interface. Communication connections established via the network interface devices can be used to connect the computing system 1004 to a computer network. A computer network is a telecommunications network that enables computers, and possibly other devices, to exchange data and share resources along data connections. There are many different types of computing networks that exhibit a variety of characteristics such as topology, connection method, and scale. Examples of computer networks include a local area network, a wide area network, the Internet, or other networks.

The computing system 1004 can also include one or more mass storage devices. The one or more mass storage devices can be removable or non-removable, and can include, without limitation, a magnetic storage device (e.g., a hard disk), an optical storage medium (e.g., a compact disc (CD) drive or a digital versatile disc (DVD) drive), a high-definition optical storage medium, an electronic storage device (e.g., an erasable programmable read-only memory (EPROM) or a flash drive), solid-state memory, flash storage devices, or other data storage devices known in the art. Computer storage media can include volatile, non-volatile, removable, and non-removable media configured to store information such as, for example, computer-readable instructions, data arrangements, program components, or other information. For example, computer storage media can include, without limitation, random access memory (RAM), read-only memory (ROM), electrically erasable programmable read-only memory (EEPROM), flash memory, solid-state memory, CD-ROM, DVD memory, or other optical storage, magnetic cassettes, magnetic tape, magnetic disk storage or other magnetic storage devices, a universal serial bus (USB) flash drive, a flash memory card, or other flash storage devices, or any other storage medium that may be configured to store computer-readable information and that can be read by the computing system 1004. The one or more memory devices and the one or more mass storage devices may be employed to store a working copy and a permanent copy of programming instructions, for implementing various aspects of the embodiments of the present disclosure. The components of the computing system 1004 can be coupled together by way of a bus, which may represent one or more buses.

The neuromodulation surgical training system 1000 may include a virtual training model 1016. The virtual training model 1016 may comprise a virtual image or three-dimensional (3D) model generated by the computing system 1004 and displayed on the display device 1008. Illustratively, the virtual training model 1016 may be configured to simulate structural characteristics of a portion of the anatomy of interest, for example, the pelvis. Although certain devices, systems, methods, and kits are described herein with respect to training a user within the pelvic region, the methods and devices can be used in other regions of the body or to train users for surgical techniques used for treating other conditions as described elsewhere herein. The virtual training model 1016 may be configured to simulate any internal or external anatomical characteristics of a patient. For example, the virtual training model 1016 may be configured to simulate bone as well as other anatomy, for example, muscle tissue, fat tissue, ligament tissue, internal organs, skin, and/or nerve tissue. The virtual training model 1016 may comprise a target nerve. For example, for a virtual training model 1016 of a pelvic area, the target nerve may comprise one or more of the pudendal nerve, tibial nerve, peroneal nerve, sacral nerve, cauda equina, pelvic parasympathetic nerves, lumbar sympathetic nerves, and/or nerve branches leading to and from such nerves. The target nerve may be depicted in the virtual training model 1016. In some embodiments, the target nerve may not be depicted in the virtual training model 1016, but may comprise a predetermined location within the virtual training model 1016 representative of where the target nerve would be located in the anatomy. The virtual training model 1016 need not be an accurate representation of any specific portion of anatomy. The virtual training model 1016 may comprise a virtual image or 3D model generated by the computing system 1004. For example, the training model 1016 may comprise a virtual image or 3D model configured to simulate the anatomical area of interest. The virtual training model 1016 may comprise different modes with different anatomical views. For example, one mode of the virtual training model 1016 may visually represent a live patient on an operating table, e.g., no internal anatomical features of the virtual training model 1016 are visible. Another mode of the virtual training model 1016 may comprise additional anatomical features including one or more internal anatomical features, e.g., bone, muscle, fat, ligaments, nerves, organs, or other tissue. For example, the user may be able to visualize the target nerve(s), e.g. the pudendal and/or sacral nerve.

The training system 1000 with a virtual training model 1016 may comprise a training mode. In the training mode, the virtual training model 1016 may visually represent internal anatomical features to help a user visualize the internal anatomy during the procedure. For example, the user may be able to visualize a target nerve, e.g., a pudendal and/or sacral nerve, when inserting a virtual instrument into a virtual training model 1016 of a pelvis. When not in the training mode, the virtual training model 1016 may visually represent a live patient to be operated on, e.g., only external anatomical features or no internal anatomical features, to allow the user to visualize how a patient will appear during an actual surgical procedure. The computing system 1004 may be configured to receive an input from the user to switch the virtual training model 1016 in and out of the training mode.

In some embodiments, the neuromodulation surgical training system 1000 may comprise a physical training model 1200 used with a physical instrument. For example, the physical training model 1200 and instrument may comprise any embodiments of the physical training apparatus 200 and the stimulating needle 212, as described elsewhere in the present disclosure. The physical training model 1200 may be configured to provide haptic, e.g., tactile, feedback by applying force (actively or passively) in response to the insertion motions or other physical interactions of the user. In some embodiments, the training system 1000 may comprise an augmented environment that can visually superimpose various anatomical structures onto the physical training model 1200. The physical training model 1200 may be configured to sense physical interaction with objects, such as the physical instrument, e.g., the stimulating needle 212, or the user's hand. Information corresponding to the sensed physical interaction may be transmitted to the computing system 1004 and incorporated into the virtual or augmented environment.

Physical interaction between the user, the physical instrument, and the physical training model 1200 may be captured by an external sensing system, such as, by way of non-limiting example, an array of sensing electrodes, an optical tracking system, position/orientation sensors, or some combination of one or more sensors disclosed elsewhere herein. The external sensing system can be configured to obtain position, orientation and motion information of the user, the instrument, the physical training model 1200, and other objects used in the training system 1000. The information sensed by the external sensing system can be transmitted to the computing system 1004. The computing system 1004 is configured to receive the information and to display it in the virtual or augmented environment in a realistic manner. The external sensing system may detect the position and orientation of the physical training model 1200 in three-dimensional, physical space. The external sensing system can also be configured to measure the position of the instrument, in three-dimensional, physical space, to estimate the position of the instrument relative to the physical training model 1200 and relative to a target nerve of the training model 1200. For example, the external sensing system may comprise an array of one or more sensing electrodes configured to interact with a stimulating needle to determine a position of the stimulating needle, as described elsewhere in the present disclosure.

In some embodiments, one or more sensors, such as, an array of one or more sensing electrodes, are placed within or proximate to the physical training model 1200 to gain a perspective of a stimulating instrument from a perspective proximate or interior to the physical training model 1200 during a procedure. The sensor(s) can detect and transmit information to the computing system 1004, which can calculate a position of the stimulating instrument based on the readings, as described elsewhere in the present disclosure. The computing system 1004 may then display the results relating to the determined position of the stimulating instrument in the virtual or augmented environment.

The external sensing system may be a position, optical, light, and/or magnetic sensing system configured to measure the displacement of a physical instrument in three-dimensional, physical space, to estimate the pathway of the instrument within the physical training model 1200. In some embodiments, an external sensing system may be configured to optically track the position and orientation of the physical training model 1200 and/or a physical instrument within the training model 1200. In some embodiments, the external sensing system periodically emits a light or other source of electromagnetic radiation which is reflected from the instrument. In some embodiments, the external sensing system comprises infrared cameras configured to detect infrared markers on the physical training model 1200 and/or instrument. The external sensing system may be able to directly communicate with the computing system 1004, or may include an integrated network system capable of communicating with the computing system 1004. The computing system 1004 may be able to display the results in a virtual or augmented environment based on the information received from the external sensing system. The results may indicate to the user how close the instrument is to a target nerve, e.g., a pudendal and/or sacral nerve, within the physical training model.

The display device 1008 may comprise a remote screen display configured to provide images of the generated virtual or augmented environment. In some embodiments, the display device 1008 may be a display that shares a same hardware architecture as the computing system 1004 and/or the user input device 1012. The neuromodulation surgical training system 1000 may provide information and training results of a surgical procedure. For example, the neuromodulation surgical training system 1000 used for training a lead implantation procedure may provide information and/or results to a user through, for example, a patient's anatomy shown on the display device, x-ray images, and/or EMG responses shown on the display device 1008, such as on a tablet, mobile device, laptop or standalone display. Although certain examples are described using x-ray images, the images may also be computer generated image or animation, MRI images, CT images, ultrasound images, or images from any other medical imaging device.

In some embodiments, the display device 1008 may include a head-mounted display to be worn by a user, e.g., wearable glasses and/or headset. The display device 1008 may be configured to provide stereoscopic images of the generated virtual or augmented environment. The computing system 1004 may be configured to simulate a virtual or augmented environment with a sufficient degree of fidelity to cause the user to perceive that he or she is present and engaged in a realistic scenario. The computing system 1004 may generate stereoscopic images (also referred to as three-dimensional images) of the environment to create the illusion of depth by presenting two separate, offset images to the user's left eye and right eye. The separate, two-dimensional images may be combined in the user's brain to create a perception of three-dimensional depth and texture. In some embodiments, the stereoscopic, head-mounted display device 1008 can provide a wide field of view, stretching beyond the user's peripheral vision. In some embodiments, the head-mounted display device 1008 may include the capability to track motions of the user's head, which are transmitted to the computing system 1004. The computing system 1004 modifies the orientation of the virtual or augmented environment in response to the user's head motion, thereby creating for the user a sense of presence within the virtual or augmented environment. The combination of the wide field of view with the features of head-tracking and stereoscopic, three-dimensional imaging may create a natural, intuitive, and immersive experience for the user.

In some embodiments, the display device 1008 may be used to display a computer-generated user prompt or one or more training module(s). For example, the display device 1008 may be used to display a user prompt with one or more instructions for the user. In another example, the display device 1008 may be used to display a training module(s). The training module(s) may comprise a checklist of items for the user to complete during a training procedure. The training module(s) may comprise a quality tracking module, as described elsewhere in the present disclosure. The training module(s) may comprise one or more virtual buttons used to switch between visual modes of a virtual training model 1016. The training module(s) may comprise one or more computer-generated warnings or alerts for the user during the training procedure.

The display device 1008 may be used to display a computer-generated three dimensional image(s) of a virtual training model 1016. The computer-generated image(s) can correspond to one or more layers of patient anatomy (e.g., bones, nerves, blood vessels, or the like) for the specific model. In some embodiments, the computer-generated image(s) can correspond to a live patient in an operating position. The images can be obtained using a CT scan, an MRI scan, a photographic image, an X-ray, and/or the like.

In some embodiments, the display device 1008 may be used to display a computer-generated three-dimension image(s) of a virtual anatomy and virtual instruments based on communicated positions and orientation information provided from a physical training model 1200 and/or a physical instrument. In some embodiments, the display device 1008 can be used to overlay a computer-generated two-dimensional or three-dimensional image(s) on a physical training model 1200 comprising a physical training apparatus 200, as described elsewhere in the present disclosure. The computer-generated image(s) can correspond to one or more layers of anatomy (e.g. bones, nerves, blood vessels, or the like) for the specific model. The images can be obtained using a CT scan, an MRI scan, a photographic image, an X-ray, and/or the like.

The generated virtual or augmented environment can depict a portion of an anatomy on which the surgical procedure, e.g., insertion of an stimulating needle, may be performed. Display of the anatomy may not be limited to constraints found in the physical world. Accordingly, the user can select a display format that provides increased or altered perception of the virtual anatomical structure being injected. For example, the user may select a training mode display format, as described elsewhere in the present disclosure. Illustratively, the user may desire to see the underlying structure of the anatomy, such as bones, nerves, blood vessels, or the like. By implementing a virtual environmental control, such as for example, a hand gesture, the user can cause the desired portion of the anatomy to be displayed. In a similar manner, the user can change perspective views of the virtual anatomy by, for example, zooming in or out, panning left or right, or rotating up, down or around the virtual anatomy.

The neuromodulation surgical training system 1000 may comprise a user input device 1012. The user input device 1012 may allow the user to interact with the virtual or augmented environment generated by the computing system 1004. For example, the user input device 1012 may be used to move through steps or switch modes of the training process, e.g., by pointing the input device towards a virtual button and/or by clicking a physical button on the device. In some embodiments, the neuromodulation surgical training system 1000 may use a virtual or augmented environment for training without a physical training model or physical instruments. In such embodiments, the user can simulate a surgical training procedure by moving the user input device 1012 in the physical world and having such motion depicted in the virtual or augmented environment, as described above.

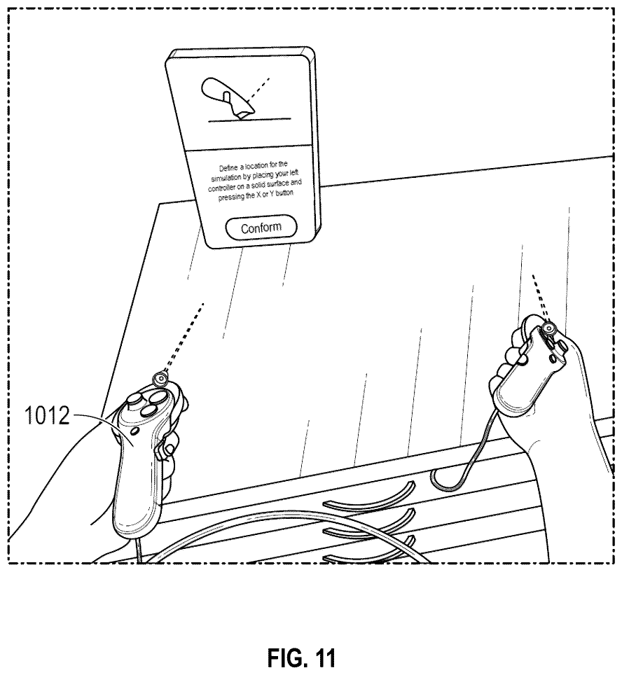

Illustratively, as shown in FIG. 11, the user input device 1012 is depicted as one or more handheld controllers. The user input device 1012 may comprise one or more position and/or orientation sensors to detect the device movement and/or position/orientation. The sensors may include an accelerometer, a gyroscope, and/or a magnetometer. In some implementations, the sensors may include a three-axis accelerometer. The user input device 1012 may be able to communicate directly, or via a network 1002, with the computing system 1004. The computing system 1004 may be able to cause the display device 1008 to display a virtual instrument relative to a virtual training model based on position, orientation, and/or other user input information provided by the user input device 1012. For example, the neuromodulation surgical training system 1000 may require the user to define a location in three-dimensional space for generating an augmented training simulation environment. The user input device 1012 and the one or more sensors of the user input device may be used to define the location and communicate the information to the computing system 1004. For example, as shown in FIG. 11, a user may define a location for the augmented simulation environment by placing the user input device 1012, e.g., a handheld controller, on a solid surface and pressing a button on the user input device 1012. Once a location is defined, the computing system 1004 may generate a virtual training model 1016 and cause the display device 1008 to display the training model in a fixed position in the augmented environment. The user input device 1012 may be used to control the movement of a virtual instrument, e.g., a virtual stimulating needle.

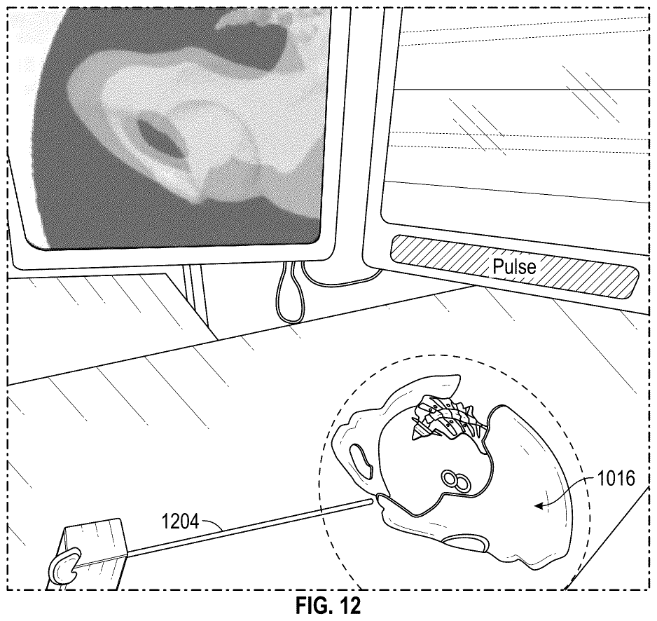

FIG. 12 illustrates an example augmented environment including a virtual instrument 1204 entering a virtual training model 1016 that represents anatomy of the pelvis. The user input device 1012 may be used to control the movement of the virtual instrument 1204, e.g., a stimulating needle. For example, a handheld controller may be used to control the movement of a virtual instrument 1204, e.g., a needle, displayed in the virtual or augmented environment. The virtual instrument 1204 may mimic the movement of the user input device 1012 in the real world. In the virtual or augmented environment, as the virtual instrument 1204 approaches the virtual training model 1016, sensory indicators may be displayed, in an overlay manner for example, to indicate proximity of the virtual instrument to the target nerve, such as the pudendal nerve and/or sacral nerve. Such sensory indicators may include, by way of non-limiting example, audible sounds, visual displays, or haptic feedback such as vibrations. As the virtual instrument approaches and penetrates the virtual training model 1016, the user may receive haptic feedback in the user input device 1012, e.g., a vibration in the handheld controller. The virtual instrument 1204 may be moved further within the virtual training model by movement of the user input device 1012. The movement and position/orientation data from the user input device 1012 may be communicated to the computing system 1004, which may determine the position of the virtual instrument 1204. The computing system 1004 may cause the display device 1008 to show the virtual instrument 1204 at the determined position relative to the virtual training model 1016 and the target location. The data from the user input device 1012 and computing system 1004 may be used to determine how close the virtual instrument 1204 is relative to the target location within the virtual training model 1016 representing a target nerve. The user input device 1012 may comprise two controllers, e.g., handheld controllers. In some embodiments, a first controller may be used for controlling the virtual instrument, and a second controller may be used to control other aspects of the training procedure. For example, the second controller may be used to receive an input from the user to deliver a simulated pulse, and communicate the input to the computing system 1004. In response to said input, the computing system 1004 may generate a visual representation of feedback from a simulated pulse, e.g., a simulated EMG response, based on a determined position of the virtual instrument 1204 relative to the virtual training model 1016.

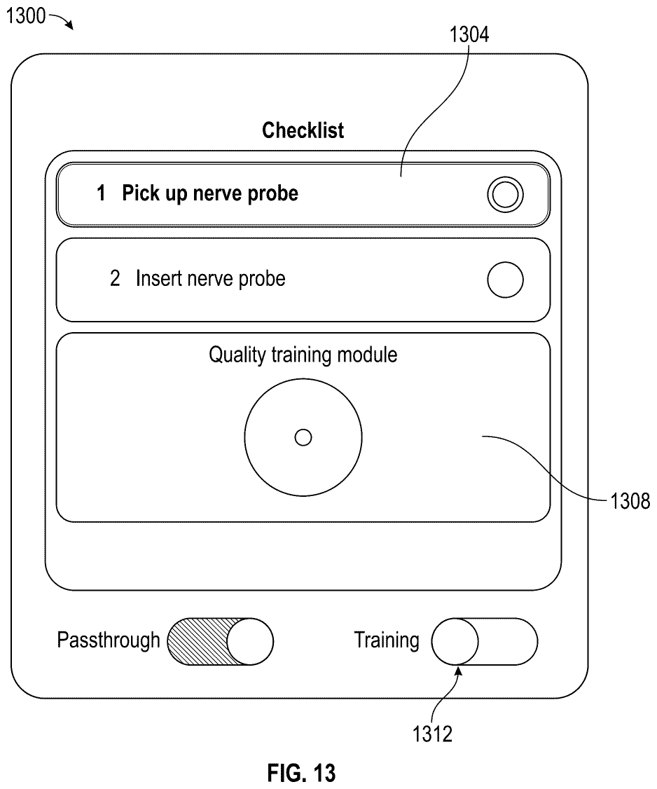

In some embodiments, the computing system 1004 may generate a virtual training module and cause the module to be displayed on the display device 1008. FIG. 13 illustrates an example virtual training module 1300 displayed on a head-mounted display in an augmented reality environment. The virtual training module 1300 may comprise a checklist 1304. The checklist may comprise one or more steps of the training procedure to be completed by a user. For example, the checklist may comprise the step of picking up an instrument. The step of picking up an instrument may be completed by picking up a user input device 1012, or pressing a button on the user input device 1012. In some embodiments, the step of picking up an instrument may be completed by picking up a physical instrument. The checklist step may be manually marked as completed by the user using the user input device 1012. In some embodiments, the checklist step may be automatically marked as completed based on a verification from one of more internal or external sensing systems in communication with the computing system 1004.

The virtual training module 1300 may comprise a tracking module 1308. In some embodiments, once a virtual instrument 1204 has been inserted into a virtual training model 1016, the virtual instrument 1204 may be fixed in one or more three-dimensional planes shared with the training model 1016. For example, the virtual instrument 1204 may be fixed in a plane parallel to the sagittal plane of the training model 1016. Thus, when the user input device 1012 is moved in a direction away from the one or more planes, the fixed virtual instrument 1204 may not mimic the movement of the user input device 1012. The tracking module 1308 may be configured to visually represent the distance of the user input device 1012 from the fixed three-dimensional (3D) position of the virtual instrument 1204. The tracking module 1308 may visually represent that the user input device 1012 is within range of the fixed position of the virtual instrument 1204. For example, the tracking module 1308 may be displayed in a green color when the user input device 1012 is within range. The tracking module 1308 may visually represent that the user input device 1012 has moved a threshold distance away, e.g., out of range, from the fixed position of the virtual instrument 1204. For example, the tracking module 1308 may be displayed in the color red. In some cases, the user input device 1012 may vibrate to indicate that it has moved out of range of the fixed position of the virtual instrument 1204.

The virtual training module 1300 may comprise one or more mode switches, e.g., a training mode switch 1312. The virtual training module 1300 may visually display whether a certain mode is “on” or “off.” For example, in FIG. 13, the training module 1300 shows that the training mode switch 1312 is off and the passthrough mode switch is on. The user input device 1012 may be used to switch the modes on or off.

The computing system 1004 may generate visual feedback for the training procedure and cause the visual feedback to be displayed on the display device 1008. The visual feedback may comprise one or more virtual simulated images of the anatomy of the training model 1016. The one or more virtual simulated images may have any of the features disclosed elsewhere herein with respect to the displayed image(s) in embodiments of training system 100. For example, the one or more virtual simulated images may comprise an x-ray image of the modeled anatomy including a depiction of an elongate instrument. The simulated image may comprise any other type of medical image discussed elsewhere herein. Additionally, or alternatively, the visual feedback may comprise one or more virtual simulated responses of a live patient. The one or more virtual simulated responses may have any of the features disclosed elsewhere herein with respect to the simulated responses of training system 100. For example, the visual feedback may comprise one or more simulated EMG responses shown on a virtual monitoring unit.

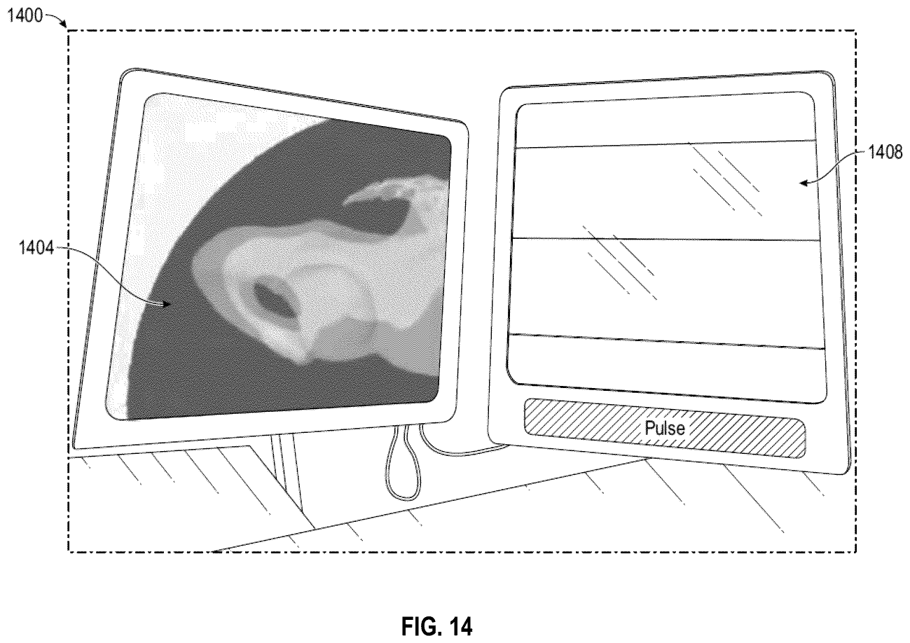

FIG. 14 illustrates an example augmented environment including visual feedback 1400 at the start of a training procedure for implanting an electrode lead within the pelvic area. The visual feedback 1400 may comprise a virtual x-ray 1404 and a virtual monitoring unit 1408. The virtual x-ray 1404 may comprise a simulated x-ray image(s) of the training model 1016. As shown in FIG. 14, the virtual x-ray 1404 may be in a lateral view, or in any other view disclosed herein. The x-ray image(s) may be of a computer-generated x-ray image. In some embodiments, the x-ray image(s) may comprise a real x-ray image of the anatomy from a database of images. The user may be able to visualize the depth of instrument as it enters the training model and when it is close to a target nerve, e.g., a pudendal nerve, of the virtual training model 1016. The type of view may vary depending on the surgical procedure being trained.

The virtual monitoring unit 1408 may show simulated EMG responses from one or more different areas of interest, such as the pelvic floor, left external anal sphincter, and right external anal sphincter. The simulated EMG responses may be representative of a live patient and may indicate the proximity of the virtual instrument 1204 to a target nerve, e.g., a pudendal nerve, in the virtual training model 1016. For example, the instructions to output simulated bioelectrical and/or pressure responses may be pre-programmed for different positions of the virtual instrument 1204 within the virtual training model 1016. The simulated bioelectrical and/or pressure responses may be based on a dataset of actual observed responses in a live patient at different positions of a stimulating needle. In some embodiments, the computing system 1004 (e.g., one or more processors) may use machine learning and/or artificial intelligence to determine the appropriate bioelectrical and/or pressure response output based on the determined position of the virtual instrument 1204. For example, a machine learning algorithm may be trained on a dataset of observed EMG or bladder pressure responses in live patient(s) with a stimulating needle at various positions within the patient(s). In some cases, the virtual monitoring unit 1408 may output feedback comprising simulated ultrasound images showing changes in blood flow.

For systems used for training of surgical procedures using electrical stimulation, such as the implantation of electrode leads as disclosed herein, the computing system 1004 may be configured to simulate a pulse delivered by the virtual instrument 1204. The user input device 1012 may receive an input from the user to deliver a simulated pulse and communicate the input to the computing system 1004. In response to said communication, the computing system 1004 may generate visual feedback, e.g., a simulated EMG response, for the simulated pulse.

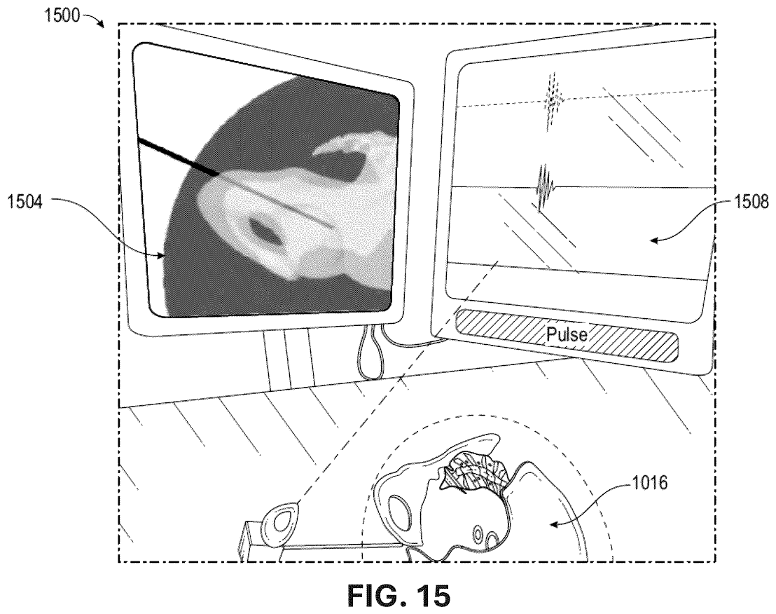

FIG. 15 illustrates an example augmented environment including visual feedback 1500 during a training procedure for implanting an electrode lead within the pelvic area. The visual feedback 1500 may comprise a virtual x-ray 1504 and a virtual monitoring unit 1508. The virtual x-ray 1504 may show a simulated x-ray image of the anatomy of the training model 1016 including a depiction of the virtual instrument 1204 at a determined position within the anatomy. The virtual monitoring unit 1508 may display a simulated EMG response to a simulated pulse. The simulated EMG response may be representative of a live patient and correspond to a position of the virtual instrument 1204 relative to a target location, e.g., a target nerve, of the virtual training model 1016. For example, when implanting an electrode lead at or adjacent to a pudendal nerve in the pelvic area, a user may want to elicit responses from at least the pelvic floor and both left and right sides of the external anal sphincter. Thus, the simulated EMG responses from the different areas of interest may indicate the proximity of the virtual instrument to a pudendal nerve or sacral nerve in the virtual training model 1016. As shown in FIG. 15, when the virtual instrument 1204 has not yet reached the target pudendal nerve or sacral nerve of the training model 1016, the virtual monitoring unit 1508 may only show an EMG response in some but not all, e.g., one out of three or two out of three, of the desired areas for eliciting a response.

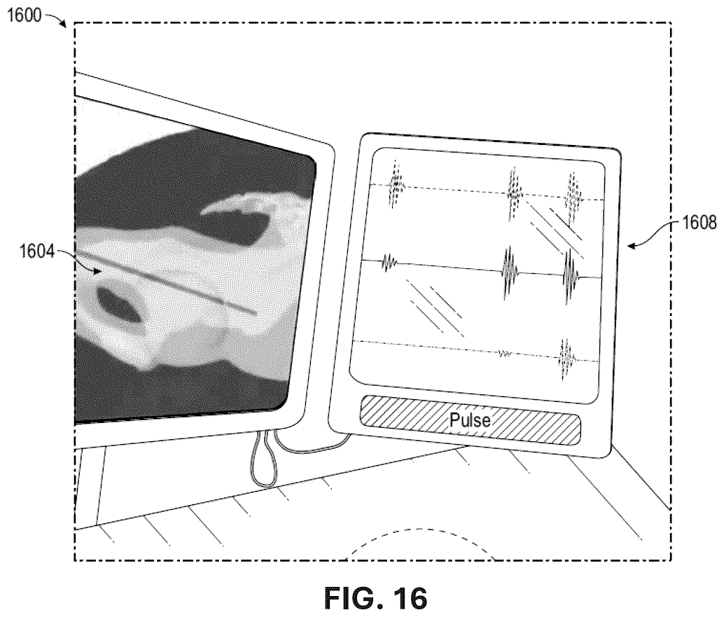

FIG. 16 illustrates another example of an augmented environment including visual feedback 1600 during a training procedure for implanting an electrode lead within the pelvic area. The visual feedback 1600 may indicate that the training procedure was successful. For example, the virtual x-ray 1604 may show that the virtual instrument has reached the target location of the virtual training model 1016, e.g., at or near the pudendal nerve. The virtual monitoring unit 1608 may show an EMG response in all three of the target areas to indicate that the virtual instrument 1204 has reached the target location in the virtual training model 1016.

As used herein throughout this application, the terms “treatment”, “treating”, or “therapy” are used in reference to an intervention regimen for obtaining beneficial or desired results in the recipient. Beneficial or desired results include but are not limited to a therapeutic benefit and/or a prophylactic benefit. A therapeutic benefit may refer to reduction, eradication, or amelioration of symptoms or of an underlying disorder being treated. Also, a therapeutic benefit can be achieved with the reduction, eradication, or amelioration of one or more of the physiological symptoms associated with the underlying disorder such that an improvement is observed in the subject, notwithstanding that the subject may still be afflicted with the underlying disorder. A prophylactic effect includes delaying, preventing, or eliminating the appearance of a disease or condition, delaying, or eliminating the onset of symptoms of a disease or condition, slowing, halting, or reversing the progression of a disease or condition, or any combination thereof. For prophylactic benefit, a subject at risk of developing a particular disease, or to a subject reporting one or more of the physiological symptoms of a disease may undergo treatment, even though a diagnosis of this disease may not have been made.

Although certain embodiments are described herein with respect to electrical stimulation or neurostimulation, the training systems described herein may be employed for a variety of modalities, including, for example, radiofrequency (RF), high power short duration RF (HPSD RF), cryoablation (CB), microwave, ultrasound, high-intensity focused ultrasound (HIFU), electroporation, steam, laser, thermal, alcohol or other or other chemical, cryo, or combinations thereof.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof and phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The terms “approximately,” “about,” and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

The section headings used herein are for organizational purposes only and are not to be construed as limiting the subject matter described.

While certain embodiments of the present disclosure have been shown and described herein, such embodiments are provided by way of example only. The phrases “in one (or some) implementations”, “in one (or some) instances”, “in one (or some) cases” shall mean “in one (or some) embodiments”. It should be understood that various alternatives within the scope of the embodiments disclosed herein (such as structural and functional equivalents) described herein may be employed.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied. In several embodiments, the systems and methods may consist or consist essentially of the features and steps recited. Disclosure of systems and methods that comprise components and steps also provides support for such systems and methods to “consist of” or “consist essentially of” those components and steps, when the latter phrases are used in the claims. As an example, disclosure herein of a training apparatus that comprises element 1 and element 2 may include additional elements or may consist or consist essentially of element 1 and element 2.

Conditional language used herein, such as, among others, “can,” “might,” “may,” “for example,” and the like, unless specifically stated otherwise, or otherwise understood within the context as used, is generally intended to convey that certain examples include, while other examples do not include, certain features, elements and/or states. Thus, such conditional language is not generally intended to imply that features, elements and/or states are in any way required for one or more examples or that one or more examples necessarily include logic for deciding, with or without author input or prompting, whether these features, elements and/or states are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain examples require at least one of X, at least one of Y, or at least one of Z to each be present.

Methods described herein also include an instruction to perform such method (or a step of such method) and systems may include instructions for use.

Many other variations than those described herein will be apparent from this disclosure. For example, certain acts, events, or functions of any of the algorithms described herein can be performed in a different sequence, can be added, merged, or left out altogether (for example, not all described acts or events are necessary for the practice of the algorithms). Moreover, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

It is to be understood that not necessarily all such advantages can be achieved in accordance with any particular example of the examples disclosed herein. Thus, the examples disclosed herein can be embodied or carried out in a manner that achieves or optimizes one advantage or group of advantages as taught herein without necessarily achieving other advantages as may be taught or suggested herein.

The various illustrative logical blocks, modules, and algorithm steps described in connection with the examples disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the examples disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuit or digital logic circuit configured to process computer-executable instructions. In another example, a processor can include an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the examples disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

What is claimed is:

1. A surgical training system configured for training of a neuromodulation surgical technique, the system comprising:
a training apparatus comprising an anatomical model of a pelvis, an anatomical model of a nerve, and one or more sensors;
a needle configured to be inserted into the training apparatus; and
a processing unit configured to:
determine a position of the needle relative to the pelvis modeled by the training apparatus based on data received from the one or more sensors;
cause a display device to display one or more x-ray images of the pelvis including a depiction of the needle at the determined position relative to the pelvis; and
cause a monitoring unit to output feedback based on the determined position of the needle, wherein the feedback comprises one or more simulated bioelectrical responses representative of a live patient and indicative of proximity of the needle to the anatomical model of the nerve of the training apparatus.

2. The system of claim 1, wherein needle is a stimulating needle configured to output electrical stimulation, and wherein the stimulating needle is configured to be inserted into a conductive material of the training apparatus.

3. The system of claim 2, wherein the one or more sensors comprises an array of electrodes configured to sense electrical signals from the electrical stimulation.

4. The system of claim 3, wherein the array of one or more electrodes is placed along a predetermined pathway for the stimulating needle.

5. The system of claim 4, wherein the predetermined pathway follows an ischiorectal approach to the pudendal nerve of the training apparatus.

6. The system of claim 1, wherein the training apparatus further comprises one or more orientation sensors configured to measure an orientation of the training apparatus.

7. The system of claim 6, wherein the simulated x-ray image of the pelvis has an orientation corresponding to a measured orientation of the training apparatus.

8. The system of claim 1, wherein the training apparatus provides haptic feedback to the user as the needle is inserted into the training apparatus.

9. The system of claim 1, wherein the simulated x-ray image of the pelvis comprises one or more different perspective views of the pelvis.

10. A surgical training system configured for training of a neuromodulation surgical technique, the system comprising:
a training apparatus comprising an anatomical model of a pelvis and an anatomical model of a nerve, the training apparatus comprising:
a conductive material; and
an array of one or more electrodes on or within the conductive material and configured to sense electrical signals from electrical stimulation;
a stimulating needle configured to be inserted into the conductive material of the training apparatus and output the electrical stimulation; and
a processing unit configured to:
receive sensor data from the array of one or more electrodes;
determine, based on the sensor data, a position of the stimulating needle relative to the pelvis modeled by the training apparatus; and
cause an output of feedback based on the determined position of the stimulating needle, wherein the feedback comprises one or more simulated bioelectrical responses representative of a live patient and indicative of proximity of the stimulating needle to the anatomical model of the nerve of the training apparatus.

11. The system of claim 10, wherein the conductive material comprises conductive foam.

12. The system of claim 10, wherein the processing unit is configured to determine the position by calculating a distance of a portion of the stimulating needle to each of the one or more electrodes based on the sensor data.

13. The system of claim 10, wherein the array of one or more electrodes is placed along a predetermined pathway for the stimulating needle.

14. The system of claim 13, wherein the predetermined pathway follows an ischiorectal approach into the pelvis.

15. The system of claim 10, wherein the processing unit is further configured to cause a display device to display an image of the pelvis including a depiction of the stimulating needle at the determined position relative to the pelvis.

16. The system of claim 15, wherein the training apparatus further comprises one or more orientation sensors configured to measure an orientation of the training apparatus.

17. The system of claim 16, wherein the displayed image of the pelvis has an orientation corresponding to a measured orientation of the training apparatus by the one or more orientation sensors.

18. The system of claim 10, wherein the training apparatus provides haptic feedback to the user as the stimulating needle is inserted into the training apparatus.

19. The system of claim 10, wherein a monitoring unit outputs the feedback comprising one or more simulated bioelectrical responses.

20. A non-transitory, computer-readable medium comprising computer executable instructions for training a neuromodulation surgical technique associated with a nerve, wherein the computer-executable instructions, when executed by a computer system, cause the computer system to:
receive data from one or more sensors of a training apparatus comprising an anatomical model of a pelvis;
determine a position of a stimulating needle inserted into the training apparatus, based on the data received from the one or more sensors;
generate an image of the pelvis including a depiction of the stimulating needle at the determined position relative to the pelvis;
cause an output of feedback based on the determined position of the instrument, wherein the feedback comprises one or more simulated bioelectrical responses representative of a live patient and indicative of a proximity of the instrument to a nerve of the training apparatus.
